(19) United States
(12) Patent Application Publication
(10) Pub. No.: US 2005/0160238 A1
(43) Pub. Date: Jul. 21, 2005

(54) System and method for conflict responses in a cache coherency protocol with ordering point migration

(76) Inventors: Simon C. Steely JR., Hudson, NH (US); Gregory Edward Tierney, Chelmsford, MA (US); Stephen R. Van Doren, Northborough, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/761,073

(22) Filed: Jan. 20, 2004

(51) Int. Cl. G06F 12/00

(52) U.S. Cl. 711/145; 711/133; 711/158

(57) ABSTRACT

A system comprises a first node that provides a source broadcast request for data. The first node is operable to respond in a first manner to other source broadcast requests for the data while the source broadcast for the data is pending at the first node. The first node is operable to respond in a second manner to the other source broadcast requests for the data in response to receiving an ownership data response at the first node.

### RELATED APPLICATIONS

This application is related to the following commonly assigned co-pending patent applications:

“CACHE COHERENCY PROTOCOL WITH ORDERING POINTS,” Attorney Docket No. 200313588-1; “SYSTEM AND METHOD FOR RESOLVING TRANSACTIONS IN A CACHE COHERENCY PROTOCOL,” Attorney Docket No. 200313589-1; “SYSTEM AND METHOD TO FACILITATE ORDERING POINT MIGRATION,” Attorney Docket No. 200313612-1; “SYSTEM AND METHOD TO FACILITATE ORDERING POINT MIGRATION TO MEMORY,” Attorney Docket No. 200313613-1; “SYSTEM AND METHOD FOR CREATING ORDERING POINTS,” Attorney Docket No. 200313614-1; “SYSTEM AND METHOD FOR CONFLICT RESPONSES IN A CACHE COHERENCY PROTOCOL WITH ORDERING POINT MIGRATION,” Attorney Docket No. 200313615-1; “SYSTEM AND METHOD FOR READ MIGRATORY OPTIMIZATION IN A CACHE COHERENCY PROTOCOL,” Attorney Docket No. 200313616-1; “SYSTEM AND METHOD FOR BLOCKING DATA RESPONSES,” Attorney Docket No. 200313628-1; “SYSTEM AND METHOD FOR NON-MIGRATORY REQUESTS IN A CACHE COHERENCY PROTOCOL,” Attorney Docket No. 200313629-1; “SYSTEM AND METHOD FOR CONFLICT RESPONSES IN A CACHE COHERENCY PROTOCOL,” Attorney Docket No. 200313631-1; “SYSTEM AND METHOD FOR RESPONSES BETWEEN DIFFERENT CACHE COHERENCY PROTOCOLS,” Attorney Docket No. 200313632-1, all of which are filed contemporaneously herewith and are incorporated herein by reference.

### BACKGROUND

Multi-processor systems employ two or more computer processors that can communicate with each other, such as over a bus or a general interconnect network. In such systems, each processor may have its own memory cache (or cache store) that is separate from the main system memory that the individual processors can access. Cache memory connected to each processor of the computer system can often enable fast access to data. Caches are useful because they tend to reduce latency associated with accessing data on cache hits, and they work to reduce the number of requests to system memory. In particular, a write-back cache enables a processor to write changes to data in the cache without simultaneously updating the contents of memory. Modified data can be written back to memory at a later time.

Coherency protocols have been developed to ensure that whenever a processor reads a memory location, the processor receives the correct or true data. Additionally, coherency protocols help ensure that the system state remains deterministic by providing rules to enable only one processor to modify any part of the data at any one time. If proper coherency protocols are not implemented, however, inconsistent copies of data can be generated.

There are two main types of cache coherency protocols, namely, a directory-based coherency protocol and a broadcast-based coherency protocol. A directory-based coherency protocol associates tags with each memory line. The tags can contain state information that indicates the ownership or usage of the memory line. The state information provides a means to track how a memory line is shared. Examples of the usage information can be whether the memory line is cached exclusively in a particular processor's cache, whether the memory line is shared by a number of processors, or whether the memory line is currently cached by any processor.

A broadcast-based coherency protocol employs no tags. Instead, in a broadcast-based coherency protocol, each of the caches monitors (or snoops) requests to the system. The other caches respond by indicating whether a copy of the requested data is stored in the respective caches. Thus, correct ownership and usage of the data are determined by the collective responses to the snoops.

### SUMMARY

One embodiment of the present invention may comprise a system that includes a first node that provides a source broadcast request for data. The first node is operable to respond in a first manner to other source broadcast requests for the data while the source broadcast request for the data is pending at the first node. The first node is operable to respond in a second manner to the other source broadcast requests for the data in response to receiving an ownership data response at the first node.

Another embodiment of the present invention may comprise a multi-processor network that includes a source processor node that provides a source broadcast read request for data. The source processor node issues an invalidate line command to other processor nodes of the system in response to receiving a data response that transfers a cache ordering point for the data to the source processor node.

Another embodiment of the present invention may comprise a method that includes migrating a cache ordering point for a line of data from a second node of a system to a first node of a system. The method also includes issuing an invalidate line command for the line of data to other nodes of the system in response to receiving a conflict response from at least one other node in the system and to the cache ordering point migrating from the first node to the second node.

Yet another embodiment of the present invention may comprise a method including providing from a first node a first conflict response to source broadcast requests for data from other nodes while a source broadcast for the data is pending at the first node. The method may also include providing from the first node a second conflict response to the other source broadcast requests for the data from the other nodes in response to receiving a conflict response and an ownership data response at the first node.

Still another embodiment of the present invention may comprise a computer system that includes a plurality of nodes. The plurality of nodes employ a cache coherency protocol operative to migrate a cache ordering point for a line of data from a target node to a source node in response to a source broadcast read request for the line of data issued by the source node. The source node is operative to invalidate the line of data at other nodes of the computer system in response to receiving a conflict response and migratory data to the source broadcast read request.

### BRIEF DESCRIPTION OF THE DRAWINGS

FIG. 1 depicts an example of a multi-processor system.

FIG. 2 depicts an example of a data state flow diagram that may be implemented in a coherency protocol.

FIG. 3 depicts an example of a conflict state flow diagram that may be implemented in a coherency protocol.

FIG. 4 depicts an example of another multi-processor system.

FIG. 5 depicts an example of a processor within a multi-processor system.

FIG. 6 depicts a timing diagram for a first example conflict scenario illustrating state transitions for a coherency protocol.

FIG. 7 depicts a second example conflict scenario illustrating state transitions for a coherency protocol.

FIG. 8 depicts a third example conflict scenario illustrating state transitions for a coherency protocol.

FIG. 9 depicts a fourth example conflict scenario illustrating state transitions for a coherency protocol.

FIG. 10 depicts a fifth example conflict scenario illustrating state transitions for a coherency protocol.

FIG. 11 depicts a flow diagram illustrating a method.

FIG. 12 depicts a flow diagram illustrating another method.

### DETAILED DESCRIPTION

This disclosure relates generally to systems and methods for conflict responses in a cache coherency protocol that supports migratory data. Migratory Data can be defined as a class of memory blocks that are shared by a plurality of processors and are characterized by a per processor reference pattern which includes a read and a write in close temporal proximity in the instruction stream of the processor. In general, such data blocks are expected to be shared in a manner in which each processor is provided with an opportunity to complete its read-write sequence before any other processors initiate their read-write sequence.

The per processor read-write sequence associated with Migratory Data can manifest itself in the system as a two-step per processor sequence consisting of a simple data read request (XREAD) followed by an upgrade (XUPGRADE) reference to make the line writable. An optimization is to reduce this two-step per processor sequence to a single step by implementing a single “Read with Modify Intent” (XRDINVAL) request. Implementation of the single XRDINVAL request greatly reduces the latency of the request and reduces system request traffic. The cache coherency protocol described herein provides this optimized migratory data support through implementation of the XRDINVAL request.

Migratory data support is a system function implemented through the cache coherency protocol described herein. When a processor begins a migratory data sequence, it encounters a read reference in its instruction stream that provides no indication that the read reference is operative on a migratory data line. Thus, when the read request is issued to the system by the processor, it is issued as a simple read request (XREAD). The cache coherency protocol described herein employs a predictive function to determine whether the read request is addressing a migratory data line. This predictive function can be a cache state decoding mechanism responsive to the states of all processors that are targets of snoops associated with the XREAD request. The predictive function implemented in the cache coherency protocol described herein covers a comprehensive set of coherence timing and conflict cases that can arise in during migratory data flows. Once migratory data is detected, the XREAD request is completed implementing measures to ensure that the XREAD is completed correctly.

The cache coherency protocol described herein supports migratory read commands by employing cache states (described in detail below) that function to predict whether a read command, or read snoop, involves migratory data. If a read snoop finds the requested line cached in a modified state in another cache, the data is returned to the requestor in a dirty state. Thus, in effect, when migration takes place, the migratory read command acts like a write command, moving the cache ordering point to the requesting node.

The cache coherency protocol employs conflict states that are assigned to a miss address file (MAF) entry for an outstanding broadcast snoop request. The conflict states are used to determine how to handle conflicts between MAFs that are associated with the same cache line and that are valid and/or active at the same time. The conflict states can include a read conflict (RD-CONF) state and a conflict (CONFLICT) state. In general, the RD-CONF state is assigned to a MAF entry in a conflict scenario in which migratory data has not been detected. In general, the CONFLICT state is assigned to a MAF entry in a conflict scenario in which migratory data has been detected.

The implementation of the CONFLICT and RD-CONF states can also be utilized in multi-processor systems employing a hybrid cache coherency protocol, such as the SSP/FPP hybrid cache coherency protocol described herein. In a conflict scenario in which a source processor receives a data response and a RD-CONF response to a broadcast snoop request for data, the source processor can place the data in a cache associated with the source processor. In a conflict scenario in which a source processor receives a data response and a CONFLICT response to a broadcast snoop request for data, the source processor can employ a forward progress technique to complete the request. For example, the source processor can transition to a forward progress protocol (FPP) mode and reissue the request for the data using FPP request commands. Other forward progress techniques could also be utilized. The cache coherency protocol disclosed herein thus mitigates having to transition to the FPP mode in certain conflict scenarios, which can help reduce latency.

Since migratory reads begin as simple read requests (XREAD), there can be a substantial period of time between the time a MAF for an XREAD request is created and the time when the source processor knows that the read is migratory. Prior to receiving indication that the read is migratory, the source node can respond to snoop requests from other nodes requesting the same line by providing a RD-CONF response. This can be problematic since these other processors may end up consuming stale data once the data migrates to the source processor. The cache coherency protocol described herein takes this into account by employing a migratory mode at the source processor once migration of the cache ordering point has begun. The migratory mode helps ensure correctness of the transaction, e.g., that the migratory data migrates to the source processor and that other processors requesting the same line do not consume stale data. In the migratory mode, the source processor responds to snoops for the same line from other nodes with the CONFLICT response and invalidates the line for other processors that may have received stale or incorrect data. The migratory mode will be discussed in greater detail below.

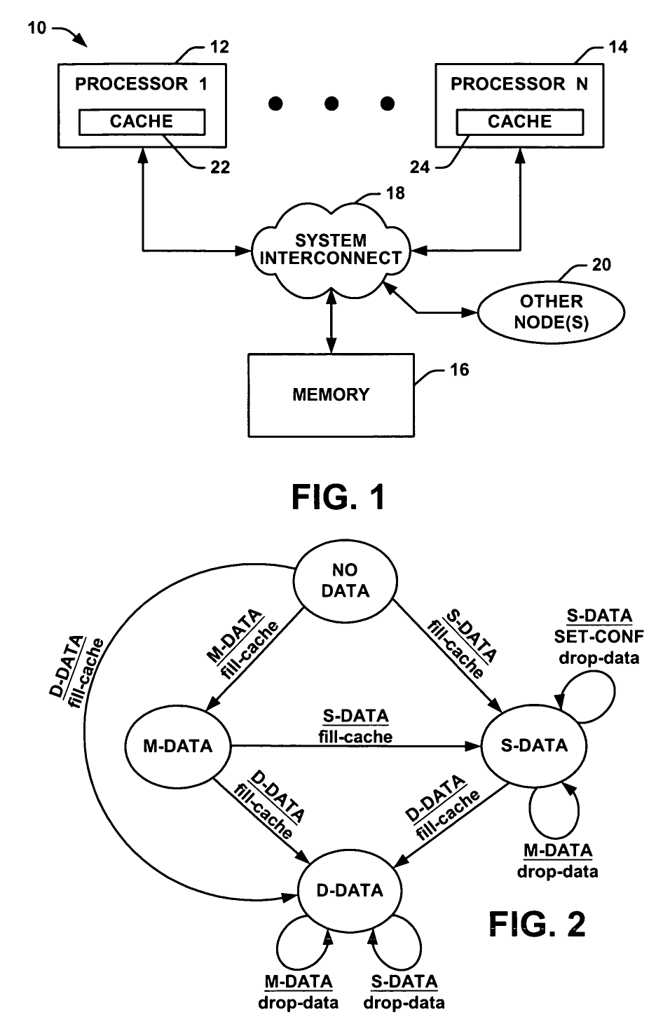

FIG. 1 depicts an example of a system 10 in which a cache coherency protocol of the present invention may be implemented. The system 10 illustrates a multi-processor environment that includes a plurality of processors 12 and 14 (indicated at PROCESSOR I through PROCESSOR N, where N is a positive integer (Na>1)). The system 10 also includes memory 16 that provides a shared address space. For example, the memory 16 can include one or more memory storage devices (e.g., dynamic random access memory (DRAM)).

The processors 12 and 14 and memory 16 define nodes in the system that can communicate with each other via requests and corresponding responses through a system interconnect 18. For example, the system interconnect 18 can be implemented as a switch fabric or a hierarchical switch. Also associated with the system 10 can be one or more other nodes, indicated schematically at 20. The other nodes 20 can correspond to one or more other multi-processor systems connected to the system interconnect 18, such as through an appropriate interconnect interface (not shown).

Each of the processors 12 and 14 includes at least one corresponding cache 22 and 24. For purposes of brevity, each of the respective caches 22 and 24 is depicted as unitary memory devices, although the caches may include a plurality of memory devices or different cache levels. Each of the caches 22 and 24 includes a plurality of cache lines. Each cache line has an associated tag address that identifies corresponding data stored in the line. The cache lines can also include information identifying the state of the data for the respective lines.

The system 10 thus employs the caches 22 and 24 and the memory 16 to store blocks of data, referred to herein as “memory blocks.” A memory block can occupy part of a memory line, an entire memory line or span across multiple lines. For purposes of simplicity of explanation, however, it will be assumed that a memory block occupies a single “memory line” in memory or a “cache line” in a cache. Additionally, a given memory block can be stored in a cache line of one or more caches as well as in a memory line of the memory 16.

Each cache line can also include information identifying the state of the data stored in the respective cache. A given memory block can be stored in a cache line of one or more of the caches 22 and 24 as well as in a memory line of the memory 16, depending on the state of the line. Whether a cache line contains a coherent copy of the data also depends on the state of the cache line. Certain states employed by the coherency protocol can define a given cache line as an ordering point for the system 10 employing a broadcast-based protocol. An ordering point characterizes a serialization of requests to the same memory line (or memory block) that is understood and followed by the system 10.

The system 10 implements the cache coherency protocol to manage the sharing of memory blocks so as to help ensure coherence of data. The cache coherency protocol of the system 10 utilizes a plurality of states to identify the state of each memory block stored in respective cache lines of the caches 22 and 24 and the memory 16. The coherency protocol establishes rules for transitioning between states, such as if data is read from or written to memory 16 or one of the caches 22 and 24.

The coherency protocol can be implemented as a hybrid cache coherency protocol, such as a broadcast source snoop protocol (SSP) implemented in conjunction with a forward progress (e.g., directory-based or null-directory) protocol (FPP). Characteristic of the hybrid cache coherency protocol, requests for data are initially transmitted broadcast using SSP broadcast snoop requests. If the snoop requests fail or otherwise cannot be completed, such as where there is a conflict between multiple processors attempting to read and/or write the same cache line, the protocol can transition to the FPP mode and the requests can be reissued using FPP request commands. Other forward progress techniques could also be utilized.

As used herein, a node that issues a request, such as a read or write request, defines a source node. Other nodes within the system 10 are potential targets of the request. Additionally, each memory block in the system 10 can be assigned a home node that maintains necessary global information and a data value for that memory block. When a source node issues a source broadcast snoop request for data, an entry associated with the request is allocated in a miss address file (MAF). The MAF maintains information associated with, for example, the address of the data being requested, the type of request, and response information received from other nodes in response to the request. The MAF entry for the request is maintained until the request associated with the MAF is complete.

For example, when a source node, such as the processor 12, requires a copy of a given memory block, the source node typically first requests the memory block from its local, private cache by comparing selected cache tags to the address associated with the memory block. If the data is found locally, the memory access is resolved without communication via the system interconnect 18. When the requested memory block is not found locally, the source node 12 can request the memory block from the system 10, including the memory 16. In addition to the request identifying an address associated with the requested memory block, the request usually identifies the type of request or command being issued by the requester. Whether the other nodes 14 and the memory 16 will return a response depends upon the type of request, as well as the state of the identified memory block if contained in the responding nodes. The cache coherency protocol implemented by the system 10 defines the available states and possible state transitions.

A set of cache states that can be included in the cache coherency protocol described herein is depicted below in Table 1. Each cache line of the respective caches 22 and 24 of the processors 12 and 14 may be associated or tagged with one of the cache states in table 1. Since there are eight possible states, the state information can be encoded by a three-bit data word, for example.

TABLE 1

| STATE | DESCRIPTION |
|---|---|
| I | Invalid - The cache line does not exist. |
| S | Shared - The cache line is valid and unmodified |
| | by caching processor. Other processors may have |
| | valid copies, and the caching processor cannot |
| | respond to snoops by returning data. |
| E | Exclusive - The cache line is valid and unmodified |
| | by caching processor. The caching processor has the |
| | only cache copy in the system and may respond to |
| | snoops by returning data. |
| F | First (among equals) - The cache line is valid and |
| | unmodified by caching processor. Other processors |
| | may have valid copies, and caching processor may |
| | respond to snoops by returning data. |
| D | Dirty - The cache line is valid and more up-to-date |
| | than memory. The cache line has not been modified by |
| | the caching processor, and the caching processor has |
| | the only cache copy in the system. The caching processor |
| | must respond to snoops by returning data and must write |
| | data back to memory upon displacement. The dirty state |
| | permits a modified block to be transferred between caches |
| | without updating memory. |
| M | Modified - The cache line is valid and has been modified |
| | by the caching processor. The caching processor has the |
| | only cache copy in the system, and the caching processor |
| | must respond to snoops by returning data and must write |
| | data back to memory upon displacement. |
| O | Owned - The cache line is valid and more up-to-date than |
| | memory. The caching processor cannot modify the cache line. |
| | Other processors may have valid copies, and the caching |
| | processor must respond to snoops by returning data and |
| | must write data back to memory upon displacement. |
| T | Transition - The cache line is in transition. The cache line |
| | may be transitioning from O, M, E, F or D to I, or the line |
| | may be transitioning from I to any one of the valid states. |

As mentioned above, the state of a cache line can be utilized to define a cache ordering point in the system 10. In particular, for a protocol implementing the states set forth in Table 1, a processor including a cache line having one of the states M, O, E, F or D may be referred to as an owner processor or node and can serve as a cache ordering point for the data contained in the cache line for transactions in the broadcast-based protocol. An owner processor (e.g., processor 12 or 14) that serves as the cache ordering point is capable of responding with data to snoops for the data. For example, processor 14 may be an owner processor for particular data and thus can provide a copy of the data to another cache 12. The type of data returned by an owner processor depends on the state of the data stored in the processor's cache. The response may also vary based on the type of request as well as whether a conflict exists. The memory 16 seeks to return a copy of the data stored in the memory. The memory copy of the data is not always a coherent copy and may be stale (e.g., when there is a modified copy of the data cached by another processor).

The cache coherency protocol described herein provides for ordering point migration in which a cache ordering point is transferred from cache of a target processor to cache of a source processor in response to a source broadcast read request depending on a migratory predictor, such as the cache state of a target processor for a line of data. For example, a target node (e.g., processor 14) including an M-state cache line can, in response to a source broadcast read request, provide an ownership data response to a source node (e.g., processor 12), and the source node cache line transitions to the D-state. Upon completion of the ordering point transfer, the target processor 14 cache line transitions to the I-state. The ordering point is thus transferred (i.e., the ordering point migrates) from the target processor 14 to the source processor 12.

To mitigate the vulnerability of the ordering point during migration, the cache line of the target processor 14 can transition to the T-state while the ordering point migration is pending. Additionally, the source processor 12 can provide a message that acknowledges when the ordering point has successfully migrated (e.g., a migration acknowledgement or “MACK” message). The cache line of the target processor 14 can further transition from the T-state to the I-state in response to receiving the MACK message from the source processor 12. The target processor 14 can respond to the MACK message by providing a further acknowledgement message back to the source processor 12 (e.g., a MACK acknowledgement or MACK-ACK message). The source broadcast read request by the source processor 12 that initiated the migration sequence can be considered completed in response to receiving the MACK-ACK message from the target processor 14.

The processors 12 and 14 of the system 10 can obtain copies of desired data by issuing data requests in either the SSP or FPP portion of the cache coherency protocol implemented in the system. A list of example data requests that can be included in the SSP portion of the cache coherency protocol described herein, and thus issued through a source broadcast request by a processor (e.g., processors 12 and 14), is depicted below in Table 2.

TABLE 2

| Request | | |
|---|---|---|
| Type | Request | Request Description |
| Reads | XREADN | Broadcast read line code: |
| | | Non-migratory read request. |
| | XREAD | Broadcast read line data: |
| | | Read request. |
| | XREADC | Broadcast read current |
| | | (non-coherent read). |
| Writes | XRDINVAL | Broadcast read and invalidate |
| | | line with owner. |
| | XUPGRADE | Broadcast invalidate line - |
| | | upgrade un-writable copy. |
| Memory | XWRITE | Broadcast memory write-back - |
| Updates | | victim write. |
| | XUPDATE | Broadcast memory update - |
| | | victim write. |
| | XWRITEC | Broadcast write coherent. |
| Special | MACK | Broadcast migration |
| Commands | | acknowledgment. |
| | XINVAL | Broadcast invalidate. |

According to the cache coherency protocol described herein, source processors 12 and 14 issue data requests initially as broadcast snoop requests using the SSP commands set forth in Table 2. If the snoop requests fail and a transition to the FPP is required (e.g., due to a conflict), the system 10 can reissue the request using a forward progress technique. For example, the system 10 can transition to an FPP mode and the requests can be reissued using FPP commands.

Whenever a broadcast read or write snoop is issued by a source node (e.g., source processor 12) in the system 10, target nodes of the system (e.g., target processor 14, memory 16, and nodes 20) may issue an SSP response to the snoop. A list of example SSP responses that may be included in the cache coherency protocol described herein is depicted below in Table 3.

TABLE 3

| SSP | |
|---|---|
| Broadcast | |
| Response | Response Description |
| D-DATA | Ownership data response - Corresponding snoop |
| | command was the first to arrive at a cache |
| | ordering point (M, O, D, E, F state); the |
| | ordering point is being transferred to the |
| | requesting processor. At most, one D-DATA |
| | command can exist per cache line at any |
| | given time. |
| S-DATA | Shared data response - Data is being returned |
| | from a cache ordering point; the ordering point |
| | is not being transferred. |
| M-DATA | Memory data response - Data is being returned |
| | from home memory. |
| MISS | General snoop response: |
| | Snoop failed to match a cache or MAF entry at a |
| | snoop target. |
| | Snoop matched at a snoop target and |
| | invalidated a cache line at the target. |
| | Acknowledgement for broadcast invalidate line |
| | requests. |
| | Acknowledgement for broadcast migration |
| | acknowledgement requests. |
| | Acknowledgement for broadcast victim |
| | write requests. |
| SHARED | Snoop hit shared - Read snoop matched on a cache |
| | line in the S-state. |
| CONFLICT | Snoop conflict - Snoop matched a valid write MAF |
| | (read or write) or T-state cache line at a target |
| | processor. |
| RD-CONF | Snoop read conflict - A special case conflict where |
| | a snoop matched a valid read MAF. |
| FPP | Snoop hit FPP-Mode MAF - Some other processor is |
| | trying to access the same cache line and has already |
| | transitioned to the forward progress protocol (FPP) |
| | mode. This response is required for forward |
| | progress/starvation avoidance. |

When a source node (e.g., source processor 12) issues a source broadcast request for data, each of the target nodes (e.g., target processor 14, memory 16, and nodes 20) having a copy of the requested data may provide a data response. In the cache coherency protocol described herein, there are three different types of data responses: shared data responses (S-DATA), dirty data responses (D-DATA), and memory data responses (M-DATA). It is thus possible that, in response to a source broadcast request for data, the source processor 12 can receive several different data responses. Accordingly, the source processor 12 requester can employ a data state machine associated with the MAF entry for the source broadcast request to manage filling data in the cache of the source processor.

FIG. 2 depicts an example of a data state diagram that represents operation of a data state machine that can be utilized to manage data responses returned to a source node in the SSP protocol. The example data state diagram of FIG. 2 implements the data responses set forth in Table 3. As shown in the data state diagram of FIG. 2, D-DATA overrides both M-DATA and S-DATA, meaning that D-DATA will result in a cache fill, overwriting M-DATA or S-DATA that is received prior to the D-DATA. Additionally, S-DATA will overwrite M-DATA, but not D-DATA. Thus, D-DATA has priority over M-DATA and S-DATA, and S-DATA has priority over M-DATA. M-DATA results in a cache fill only if no other types of data have been received. If a lower priority data is received at a requester, the requester can drop the subsequent, lower priority data. Also, as shown in FIG. 2, if multiple S-DATA responses are received, a SET-CONF condition exists and a CONFLICT message is provided to the conflict state machine associated with the MAF.

A target node can provide an ownership data response that includes D-DATA, for example, when the processor has an ownership state (e.g., M, O, E, F or D) associated with the cached data in the SSP protocol. It is the state of the cached data that defines the node (processor) as a cache ordering point for the data. When a processor responds with D-DATA, the ordering point is transferred to the requesting processor. S-DATA is a shared data response that indicates data is being returned from a cache ordering point, although the ordering point itself is not being transferred to the requester. An S-DATA response also indicates that a copy of the data may be in one or more other caches. An M-DATA response can be provided by memory (e.g., a home node) by returning the present value for the data stored in memory. It is possible that the M-DATA is stale and not up-to-date.

Examples of processor snoop responses to source broadcast snoop requests that can occur in the system 10 and the target node state transitions that result therefrom are provided in Table 4. The state transitions set forth in Table 4 assume that no conflicts are encountered in response to the respective commands. Conflict conditions can affect state transitions, as described herein. As shown in Table 4, the response to the source node varies depending on the type of broadcast snoop request received at the target node and the cache state of the target node when the snoop request is received.

TABLE 4

| Source | | Target | Target | Response |
|---|---|---|---|---|
| Node | Source | Node | Node Next | to |
| Request | Node | Cache | Cache | Source |
| Type | Request | State | State | Node |
| Reads | XREADN | T | Unchanged | Conflict |
| | XREADN | I | Unchanged | MISS |
| | XREADN | S | Unchanged | Shared |
| | XREADN | E, F | F | S-DATA |
| | XREADN | M, D, | O | S-DATA |
| | | O | | |
| | XREAD | T | Unchanged | Conflict |
| | XREAD | I | Unchanged | MISS |
| | XREAD | S | Unchanged | Shared |
| | XREAD | E, F | F | S-DATA |
| | XREAD | D, O | O | S-DATA |
| | XREAD | M | T | D-DATA |
| | XREADC | T | Unchanged | Conflict |
| | XREADC | S, I | Unchanged | MISS |
| | XREADC | M, D, | Unchanged | S-DATA |
| | | O, E, | | |
| | | F | | |
| Writes | XRDINVAL | T | Unchanged | Conflict |
| | XRDINVAL | S, I | I | MISS |
| | XRDINVAL | M, D, | T | D-DATA |
| | | O, E, | | |
| | | F | | |
| | XUPGRADE | S, I | I | MISS |
| | XUPGRADE | M, D, | Error - XUPGRADE should not | |
| | | O, E, | find an owner or T-state | |
| | | F, T | target node. | |
| Memory | XWRITE | S, I | Unchanged | MISS |
| Updates | | | | |
| | XWRITE | M, D, | Error - XWRITE should not | |
| | | O, E, | find an owner or T-state | |
| | | F, T | target node. | |
| Special | MACK | T | I | MISS |
| Commands | | | | |
| | MACK | M, D, | Error - MACK should always | |
| | | O, E, | find a T-state target node. | |
| | | F, S, | | |
| | | I | | |
| | XINVAL | T, I | Unchanged | MISS |

| | | |
|---|---|---|
| XINVAL | M, D, | Error - XINVAL should not |
| | O, E, | find an owner or S-state |
| | F, S | target node. |

Referring to Table 4 and FIG. 1, when a source node (e.g., source processor 12) issues a source broadcast request for data, each of the target processors or nodes (e.g., target processor 14 and nodes 20) may provide a non-data response. As listed in Table 3, the cache coherency protocol employs five different types of non-data responses: a general snoop response (MISS), a snoop hit shared response (SHARED), a snoop conflict response (CONFLICT), a snoop read conflict response (RD-CONF), and a snoop hit FPP mode MAF response (FPP). It is thus possible that, in response to a source broadcast request for data, the source processor 12 can receive several different non-data responses. The CONFLICT, RD-CONF, and FPP non-data responses help resolve situations where there may be more than one source processor issuing requests for the same data at any given time. Accordingly, the source processor 12 requester can employ a conflict state machine associated with the MAF entry for the source broadcast request to manage conflicts that may result from any given SSP broadcast request for data.

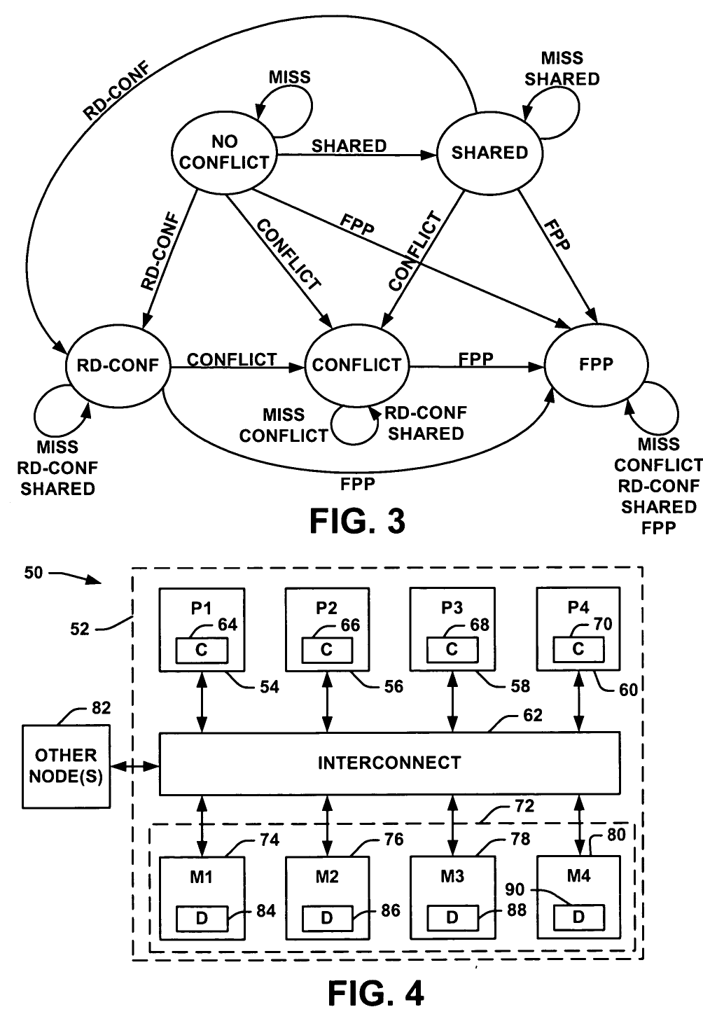

FIG. 3 depicts an example of a conflict state diagram that represents operation of a conflict state machine that can be utilized to manage non-data responses returned to a source node. The example data state diagram of FIG. 3 implements non-data responses set forth in Table 3. As shown in the conflict state diagram of FIG. 3, an FPP response has priority over the MISS, SHARED, RD-CONF, and CONFLICT responses. Thus, the FPP response can transition the cache state machine to the FPP state, regardless of the other responses received at the source node. The CONFLICT response takes priority over the MISS, SHARED, and RD-CONF responses and thus transitions the conflict state machine to the CONFLICT state. The RD-CONF response takes priority over the MISS and SHARED responses and thus transitions the conflict state machine to the RD-CONF state. The SHARED response takes priority over the MISS response and thus transitions the conflict state machine to the SHARED state. The MISS response does not transition the state of the conflict state machine. As shown in the diagram of FIG. 3, after the conflict state machine transitions to a given state, any subsequent lower priority responses will not result in a state transition.

In a conflict state machine (see, e.g., FIG. 3) associated with a MAF, the transition to the RD-CONF state may be triggered by receiving a RD-CONF response from a snooped target node. The RD-CONF transition may also be triggered by receiving an XREADN or an XREAD request from another node. In a conflict state machine associated with a MAF at the source node, the CONFLICT transition may be triggered by receiving a CONFLICT response from a snooped node. The CONFLICT transition may also be triggered by receiving an XRDINVAL, XUPGRADE, XINVAL, or XWRITE request from another node. The CONFLICT transition may also be triggered by receiving a SET-CONF message from the data state machine associated with the MAF, as described herein with respect to FIG. 2. The CONFLICT transition may also be triggered by snooping a target node having a T-state for the requested cache line, as shown in Table 4.

One type of conflict situation can occur when two or more processors each have an outstanding request for the same line of data and a MAF associated with their respective requests. The response issued by a responding target processor of the group of conflicting processors depends on the MAF state for the conflicting request of the responding target processor. A list of example target processor responses that may be issued in conflict cases according to the cache coherency protocol described herein is depicted below in Table 5.

TABLE 5

| Source | | | |
|---|---|---|---|
| Request | MAF State | Next MAF | Response |
| Type | at Target | State at Target | to Source |
| Any | Any FPP Request | Unchanged | FPP |
| Broadcast | (Except Victim) | | |
| Read or | | | |
| Write | | | |
| | Any Victim: | Unchanged | CONFLICT |
| | XINVAL | | |
| | XWRITE | | |
| | Broadcast Reads: | Per Conflict | RD-CONF |
| | XREADN | State Machine | |
| | XREAD + DSM ≠ | | |
| | D-DATA* | | |
| | XREADC | | |
| | RD-CONF | | |
| | Broadcast Writes: | Per Conflict | CONFLICT |
| | XRDINVAL | State Machine | |
| | XUPGRADE N | | |
| | XREAD + DSM = | | |
| | D-DATA* | | |
| | CONFLICT | | |

*DSM = Data State Machine (See FIG. 2)

As shown in Table 5, if a target node has an outstanding MAF in any FPP request state except a victim request when the source broadcast read or write request is received, the target node issues an FPP response to the source node and the target node MAF state remains unchanged. If a target node has an outstanding MAF in a FPP victim request state when the source broadcast read or write request is received, the target node issues a CONFLICT response to the source node and the target node MAF state remains unchanged. Also, if a target node has an outstanding MAF in one of the broadcast read states set forth in Table 5 when the source broadcast read or write request is received, the target node issues a RD-CONF response to the source node and the target node MAF state transitions according to the conflict state machine (see, e.g., FIG. 3). Further, if a target node has an outstanding MAF in one of the broadcast write states set forth in Table 5 when the source broadcast read or write request is received, the target node issues a CONFLICT response to the source node and the target node MAF state transitions according to the conflict state machine.

After all target nodes have responded to a source broadcast read/write request issued by a source node, the action taken at the source node proceeds according to several factors. These factors include the type of source broadcast read/write request issued by the source node, the resulting state of the data state machine (see, e.g., FIG. 2), and the resulting state of the conflict state machine (see, e.g., FIG. 3).

Referring back to FIG. 1, the source processor 12 can transmit a source broadcast non-migratory read snoop (XREADN, see, e.g., Table 2) to the other processor 14, to the memory 16, and to the other nodes 20 via the system interconnect 18. The other nodes in the system respond to the XREADN request by providing either a data response or a non-data response (see, e.g., Table 3), depending on factors such as the state of the respective nodes when the request is received and whether there is a conflict with the request, as described herein. The responses drive the data state machine and conflict state machine at the source processor 12 associated with the XREADN request, as described herein (see, e.g., FIGS. 2 and 3). After all responses to the XREADN request have returned from the nodes in the system 10, the resulting action taken at the source processor 12 is determined in accordance with the resulting data state/conflict state combinations, such as set forth below in Table 6.

TABLE 6

| Data State | Conflict State | |
|---|---|---|
| Machine | Machine | Action Taken at Source Node |
| NO-DATA | Don't Care | Transition to FPP mode and reissue |
| | | using FPP request. |
| Don't | FPP | Transition to FPP mode and reissue |
| Care | | using FPP request. |
| S-DATA | NO-CONFLICT, | Fill cache with S-DATA, transition |
| | SHARED, | cache line to S-state, and |
| | RD-CONF | retire MAF. |
| S-DATA | CONFLICT | FILL-INVALID - Fill cache with |
| | | S-DATA, transition cache line |
| | | to I-state, and retire MAF. |
| D-DATA | Don't Care | Error - D-DATA not returned for |
| | | XREADN. |
| M-DATA | NO-CONFLICT, | Fill cache with M-DATA, transition |
| | SHARED | cache line to E-state, F-state, or |
| | | S-state, and retire MAF. |
| M-DATA | RD-CONF | Fill cache with M-DATA, transition |
| | | cache line to S-state, and retire MAF. |
| M-DATA | CONFLICT | Transition to FPP mode and reissue |
| | | using FPP request. |

According to the cache coherency protocol described herein, an example sequence of events for an XREADN transaction is as follows:
1. Allocate an entry in a source node MAF.
2. Broadcast the XREADN commands to the home and all processors. Set the MAF entry to a SNOOPS_PENDING state.
3. Respond to snoop responses and third party snoops in accordance with the data state machine (see, e.g., FIG. 2) and conflict state machine (see, e.g., FIG. 3) associated with the MAF entry as well as processor snoop response Table 4.
4. After all snoop responses have returned from other nodes, take actions as determined in XREADN snoop resolution Table 6 based on the data state machine and conflict state machine associated with the MAF entry.

The source processor 12 may also transmit a source broadcast read snoop (XREAD, see, e.g., Table 2) to the other processor 14, to the memory 16, and to the other nodes 20 via the system interconnect 18. The other nodes in the system respond to the XREAD request by providing either a data response or a non-data response (see, e.g., Table 3), depending on factors such as the state of the respective nodes when the request is received and whether there is a conflict with the request, as described herein. The responses drive the data state machine and conflict state machine associated with the XREAD request, as described herein. After all responses to the XREAD request have returned from the nodes in the system 10, the resulting action taken at the source processor 12 is determined in accordance with the resulting data state/conflict state combinations, such as set forth below in Table 7.

TABLE 7

| Data State | Conflict State | |
|---|---|---|
| Machine | Machine | Action Taken at Source Node |
| NO-DATA | Don't Care | Transition to FPP mode and reissue |
| | | using FPP request. |
| S-DATA | FPP | Transition to FPP mode and reissue |
| | | using FPP request. |
| S-DATA | NO-CONFLICT, | Fill cache with S-DATA, transition |
| | SHARED, | cache line to S-state, and |
| | RD-CONF | retire MAF. |
| S-DATA | CONFLICT | FILL-INVALID - Fill cache with |
| | | S-DATA, transition cache line to |
| | | I-state, and retire MAF. |
| D-DATA | NO-CONFLICT | Fill cache with D-DATA, transition |
| | | cache line to D-state, and issue |
| | | MACK. |
| D-DATA | SHARED | Fill cache with D-DATA, transition |
| | | cache line to D-state, and issue |
| | | MACK. |
| D-DATA | RD-CONF, | Fill cache with D-DATA, transition |
| | CONFLICT | cache line to D-state, transition to |
| | | migratory mode and issue XINVAL. |
| | | Issue MACK/MACK-ACK sequence |
| | | when XINVAL acknowledged. |
| D-DATA | FPP | Fill cache with D-DATA, transition |
| | | cache line to O-state, transition to |
| | | migratory mode and issue XINVAL. |
| | | Issue MACK when XINVAL acknowl- |
| | | edged. Transition to FPP and reissue |
| | | using FPP request upon MACK-ACK. |
| M-DATA | NO-CONFLICT, | Fill cache with M-DATA, transition |
| | SHARED | cache line to F-state or S-state, |
| | | and retire MAF. |
| M-DATA | RD-CONF | Fill cache with M-DATA, transition |
| | | cache line to S-state, and |
| | | retire MAF. |
| M-DATA | CONFLICT, | Transition to FPP mode and reissue |
| | FPP | using FPP request. |

According to the cache coherency protocol described herein, an example sequence of events for an XREAD transaction is as follows:
1. Allocate an entry in a source node MAF.
2. Broadcast the XREAD commands to the home and all processors. Set the MAF entry to a SNOOPS_PENDING state.
3. Respond to snoop responses and third party snoops in accordance with the data state machine (see, e.g., FIG. 2) and conflict state machine (see, e.g., FIG. 3) associated with the MAF entry as well as processor snoop response Table 4.
4. After all snoop responses have returned from other nodes, take actions as determined in XREAD snoop resolution Table 7 based on the data state machine and conflict state machine associated with the MAF entry.
5. If XREAD snoop resolution Table 7 indicates a transition to migratory mode:
   a) Broadcast XINVAL commands to other processors.
   b) Respond to third party snoops with the CONFLICT response.
   c) After all XINVAL responses have returned, initiate MACK/MACK-ACK sequence.

According to the cache coherency protocol described herein, a D-DATA response is predictive or indicative of migratory data. A CONFLICT or RD-CONF response from a target node indicates that a stale or incorrect M-DATA response provided by an owner node may have been consumed at the target node and, therefore, clean-up is required. Thus, as shown in Table 7, the source processor 12 enters the migratory mode when the MAF for the XREAD request has a D-DATA state for the associated data state machine and a conflict (CONFLICT or RD-CONFLICT) for the associated conflict state machine. In the migratory mode, the source processor 12 issues an XINVAL command to all of the other processors 14 and 20 in the system 10, except the owner processor. This eliminates any misleading RD-CONF states at the other processors 14 and 20 by invalidating any stale or incorrect data that may have been filled in the other processors after migration of the data to the source processor 12 was initiated. While migration is pending at the source processor 12, the source processor responds to any third party snoop requests with a CONFLICT response. Once the source processor 12 receives acknowledgment of the XINVAL commands issued to the other processors 14 and 20, the source processor issues a MACK message to the owner processor to acknowledge receipt of the migratory data. Upon receiving the MACK message from the source processor 12, the owner processor issues a MACK-ACK message to the source processor, and migration of the data is complete.

The source processor 12 may also transmit a source broadcast read current snoop (XREADC, see Table 2) to the other processor 14, to the memory 16, and to the other nodes 20 via the system interconnect 18. The other nodes in the system 10 respond to the XREADC request by providing either a data response or a non-data response (see Table 3), depending on factors such as the state of the respective nodes when the request is received and whether there is a conflict with the request, as described herein. The responses drive the data state machine and conflict state machine at the source processor 12 associated with the XREADC request, as described herein. After all responses to the XREADC request have returned from the nodes in the system 10, the resulting action taken at the source processor 12 is determined in accordance with the resulting data state/conflict state combinations, as set forth below in Table 8.

TABLE 8

| Data State | Conflict State | |
|---|---|---|
| Machine | Machine | Action Taken at Source Node |
| NO-DATA | Don't Care | Transition to FPP mode and reissue |
| | | using FPP request. |
| S-DATA | FPP | Transition to FPP mode and reissue |
| | | using FPP request. |
| S-DATA | NO-CONFLICT, | FILL-INVALID - Fill cache with |
| | SHARED, | S-DATA, transition cache line to |
| | RD-CONF, | I-state, and retire MAF. |
| | CONFLICT | |
| D-DATA | Don't Care | Error - D-DATA not returned for |
| | | XREADC. |
| M-DATA | NO-CONFLICT, | FELL-INVALID - Fill cache with |
| | SHARED, | M-DATA, transition cache line to |
| | RD-CONF | I-state, and retire MAF. |
| M-DATA | CONFLICT, | Transition to FPP mode and reissue |
| | FPP | using FPP request. |

According to the cache coherency protocol described herein, an example sequence of events for an XREADC transaction is as follows:
1. Allocate an entry in a source node MAF.
2. Broadcast the XREADC commands to the home and all processors. Set the MAF entry to a SNOOPS_PENDING state.
3. Respond to snoop responses and third party snoops in accordance with the data state machine (see, e.g., FIG. 2) and conflict state machine (see, e.g., FIG. 3) associated with the MAF entry as well as processor snoop response Table 4.
4. After all snoop responses have returned from other nodes, take actions as determined in XREADC snoop resolution Table 8 based on the data state machine and conflict state machine associated with the MAF entry.

The source processor 12 may also transmit a source broadcast read and invalidate line with owner snoop (XRDINVAL, see, e.g., Table 2) to the other processor 14, to the memory 16, and to the other nodes 20 via the system interconnect 18. As mentioned above, the XRDINVAL serves as a “read with modify intent” request. The other nodes in the system respond to the XRDINVAL request by providing either a data response or a non-data response (see, e.g., Table 3), depending on factors such as the state of the respective nodes when the request is received and whether there is a conflict with the request, as described herein. The responses drive the data state machine and conflict state machine associated with the XRDINVAL request, as described herein. After all responses to the XRDINVAL request have returned from the nodes in the system 10, the resulting action taken at the source processor 12 is determined in accordance with the resulting data state/conflict state combinations, as set forth below in Table 9.

TABLE 9

| Data State | Conflict State | |
|---|---|---|
| Machine | Machine | Action Taken at Source Node |
| NO-DATA | Don't Care | Transition to FPP mode and reissue |
| | | using FPP request. |
| S-DATA | Don't Care | Error - S-DATA not returned for |
| | | XRDINVAL. |
| Don't Care | SHARED | Error - XRDINVAL should return |
| | | MISS response. |
| D-DATA | NO-CONFLICT, | Fill cache with D-DATA, transition |
| | RD-CONF, | cache line to D-state, and issue |
| | CONFLICT | MACK. |
| D-DATA | FPP | Fill cache with D-DATA, transition |
| | | cache line to O-state, and |
| | | issue MACK. |
| M-DATA | NO-CONFLICT, | Fill cache with M-DATA, transition |
| | RD-CONF | cache line to E-state, and retire |
| | | MAF. |
| M-DATA | CONFLICT, | Transition to FPP mode and reissue |
| | FPP | using FPP request. |

According to the cache coherency protocol described herein, an example sequence of events for an XRDINVAL transaction are as follows:
1. Allocate an entry in a source node MAF.
2. Broadcast the XRDINVAL commands to the home and all processors. Set the MAF entry to a SNOOPS_PENDING state.
3. Respond to snoop responses and third party snoops in accordance with the data state machine (see, e.g., FIG. 2) and conflict state machine (see, e.g., FIG. 3) associated with the MAF entry as well as processor snoop response Table 4.
4. When all snoop responses have returned from other nodes, take actions as determined in XRDINVAL snoop resolution Table 9 based on the data state machine and conflict state machine associated with the MAF entry.
5. If the XRDINVAL snoop resolution Table 9 indicates an “Issue MACK” action, initiate MACK/MACK-ACK sequence.

The source processor 12 may also transmit a source broadcast upgrade/invalidate line snoop (XUPGRADE, see, e.g., Table 2) to the other processor 14, to the memory 16, and to the other nodes 20 via the system interconnect 18. The other nodes in the system respond to the XUPGRADE request by providing a non-data response (see, e.g., Table 3), depending on factors such as the state of the respective nodes when the request is received and whether there is a conflict with the request, as described herein. The responses drive the data state machine and conflict state machine associated with the XUPGRADE request, as described herein. After all responses to the XUPGRADE request have returned from the nodes in the system 10, the resulting action taken at the source processor 12 is determined in accordance with the resulting data state/conflict state combinations, such as set forth below in Table 10.

TABLE 10

| Data State | Conflict State | |
|---|---|---|
| Machine | Machine | Action Taken at Source Node |
| NO-DATA | NO-CONFLICT, | Transition cache line to D-state, |
| | RD-CONF, | and retire MAF. |
| | CONFLICT | |
| NO-DATA | SHARED | Error - XUPGRADE should return |
| | | MISS response. |
| NO-DATA | FPP | Transition to FPP mode and reissue |
| | | using FPP request. |
| S-DATA, | Don't Care | Error - Data is not returned for |
| D-DATA | | XUPGRADE (source node is owner). |
| M-DATA | Don't Care | Error - No message sent to memory |
| | | for XUPGRADE. |

According to the cache coherency protocol described herein, an example sequence of events for an XUPGRADE transaction is as follows:
1. Allocate an entry in a source node MAF.
2. Broadcast the XUPGRADE commands to the home and all processors. Set the MAF entry to a SNOOPS_PENDING state.
3. Respond to snoop responses and third party snoops in accordance with the data state machine (see, e.g., FIG. 2) and conflict state machine (see, e.g., FIG. 3) associated with the MAF entry as well as processor snoop response Table 4.
4. After all snoop responses have returned from other nodes, take actions as determined in XUPGRADE snoop resolution Table 10 based on the data state machine and conflict state machine associated with the MAF entry.

By way of further example, with reference to FIG. 1, assume that the processor 12 (a source node) requires a copy of data associated with a particular memory address, and assume that the data is unavailable from its own local cache 22. Since the processor 12 does not contain a copy of the requested data, the cache line of the processor may be initially in the I-state (invalid) for that data or it may contain different data altogether. For purposes of simplicity of explanation, the starting state of the source node cache line for this and other examples is the I-state. The processor 12, operating as the source node, transmits a source broadcast read snoop (XREAD) to the system 10, including the other processor 14, to the memory 16, and to the other nodes 20 via the system interconnect 18.

In this example, it is assumed that, at the time of the XREAD request, at least one other processor (e.g., processor 14) in the system 10 has an outstanding XREAD request for the same data for which the owner node 20 has not yet responded. It is further assumed that yet another processor (e.g., one of the other nodes 20) is an owner node, i.e., a cache ordering point for the data. For this example, assume that the owner node 20 has a copy of the data in an M-state cache line of the owner node.

Upon receiving the XREAD request broadcast from the source processor 12, the memory will return an M-DATA response and the owner node 20 will identify the XREAD as a migratory request based upon its own M-state cache line. In response, the owner node 20 will return D-Data to the source processor 12 and transition to the T-state (see, e.g., Table 3). In response to receiving the XREAD request broadcast from the source processor 12, target processor 14 will return a RD-CONF response because target processor 14 has not yet received a D-DATA response from owner node 20, i.e., migration has not yet begun to target processor 14 (see, e.g., Table 5).

Referring to the data state diagram of FIG. 2, the D-DATA response from the owner node 20 has priority over the M-DATA response from memory 16. As a result, after all responses to the XREAD request of the source processor 12 have been received from the nodes of the system 10, the data state machine associated with the XREAD request of the source processor 12 is in the D-DATA state. Referring to the conflict state diagram of FIG. 3, the RD-CONF response from the target processor 14 placed the conflict state machine associated with the XREAD request of the source processor 12 in the RD-CONF state. After all responses to the XREAD request of the source processor 12 have returned from the nodes in the system 10, the resulting action taken at the source processor 12 is determined in accordance with the XREAD snoop resolution table (Table 7).

Referring to Table 7, the data state machine, being in the D-DATA state, indicates to the source processor 12 that the data line was identified as migratory and, thus, the source processor 12 should follow a migratory data control flow in completing the XREAD transaction. The conflict state machine, being in the RD-CONF state, indicates that there may be a misleading conflict state at other processors, e.g., one of the other nodes 20, that requires correction. The resulting action taken at the source node 12 is to fill the source node cache with the D-DATA and transition the source node cache line associated with the data to the D-state. The source node 12 then transitions to the migratory mode and broadcasts an XINVAL command to all other processors 20 (except the target node 14) to correct any incorrect or stale data that may have been filled at the other nodes 20. While the XINVAL is pending, the source node 12 responds to any third party snoops with CONFLICT responses instead of RD-CONF responses as set forth in the “Broadcast Writes” entry of Table 5. When all XINVAL acknowledgement responses have been received, the source node 12 initiates an MACK/MACK-ACK sequence with the target processor 14 to complete the ordering point migration. Thus, in this conflicting read scenario involving migratory data, according to the cache coherency protocol described herein, the data migrates from the target processor 14 to the source processor 12 and takes steps to correct any incorrect or stale data that may have been filled in the other nodes 20.

The above example illustrates a conflict scenario that leads to one of the data state/conflict state combinations of Table 7. It will be appreciated that the other data state/conflict state combinations of Table 7 would similarly result in the corresponding source node actions illustrated in Table 7. It will also be appreciated that the various data state and conflict state combinations of Table 7 may arise in a great number of circumstances involving conflict and non-conflict scenarios. Regardless of the scenario under which these data state/conflict state combinations are achieved, the action taken at the source node will be determined according to the data state/conflict state combination when all responses are received at the source node.

For example, if the data state machine indicates NO-DATA after all snoop responses have been received, the request can be reissued in the FPP mode, as set forth in Table 7. As another example, if the conflict state machine indicates FPP and the data state machine indicates S-DATA or M-DATA, the request can be reissued in the FPP mode, as set forth in Table 7. As a further example, if the conflict state machine indicates FPP and the data state machine indicates D-DATA, the source node cache is filled with the D-DATA and transitions to the O-state. Thereafter, the source node transitions to a migratory mode, in which the node broadcasts an XINVAL that invalidates the cache line associated with the data at the other nodes. After the XINVAL is acknowledged by the other processors, an MACK/MACK-ACK sequence is initiated and, when completed, the source node transitions to the FPP mode and issues an FPP invalidate line request. Alternatively, the source node could implement other forward progress techniques (e.g., retrying in the SSP mode or employing a token based protocol).

FIG. 4 depicts an example of a multi-processor computing system 50. The system 50, for example, includes an SMP (symmetric multi-processor) processor 52 that includes processors (P1, P2, P3, P4) 54, 56, 58 and 60 in communication with each other via an interconnect 62. The interconnect 62 facilitates transferring data between processors and memory of the system 50. While four processors 54, 56, 58, and 60 are depicted in the example of FIG. 2, those skilled in the art will appreciate that a greater or smaller number of processors can be implemented in the processor 52.

Each processor 54, 56, 58, and 60 also includes an associated cache 64, 66, 68 and 70. The caches 64, 66, 68, and 70 can enable faster access to data than from an associated main memory 72 of the processor 52. The system 50 implements a cache coherency protocol designed to guarantee coherency of data in the system. By way of example, the cache coherency protocol can be implemented to include a source broadcast protocol in which broadcast snoops or requests for data are transmitted directly from a source processor to all other processors and memory in the system 50. The source broadcast protocol can further be implemented in conjunction with another forward progress protocol, such as a null-directory or other directory-based protocol. The system 50 of FIG. 2, for example, employs the source broadcast protocol to process a request for data. If the request cannot be processed using the source broadcast protocol, such as where a conflict exists, the system 50 transfers to its forward progress protocol.

The memory 72 can include multiple memory modules (M1, M2, M3, M4) 74, 76, 78 and 80. For example, the memory 72 can be organized as a single address space that is shared by the processors 54, 56, 58 and 60 as well as other nodes 82 of the system 50. Each of the memory modules 74, 76, 78 and 80 can include a corresponding directory 84, 86, 88 and 90 that defines where the corresponding coherent copy of the data should reside in the system 50. Alternatively, the memory modules may contain no directories. A coherent copy of data, for example, may reside in a home node (e.g., associated with a given memory module) or, alternatively, in a cache of one of the processors 54, 56, 58 and 60.

The other node(s) 82 can include one or more other SMP nodes associated with the SMP processor 52 via the interconnect 62. For example, the interconnect 62 can be implemented as a switch fabric or hierarchical switch programmed and/or configured to manage transferring requests and responses between the processors 54, 56, 58, and 60 and the memory 70, as well as those to and from the other nodes 82.

When the processor 54 requires desired data, the processor 54 operates as a source and issues a source broadcast snoop (e.g., a broadcast read or broadcast write request) to the system 50, including all other processors 56, 58 and 60 as well as to memory 72, via the interconnect 62. The cache coherency protocol described herein is designed to ensure that a correct copy of the data is returned in response to the source broadcast snoop.

By way of example, assume that the processor 54 (a source processor) requires a copy of data associated with a particular memory address, and assume that the data is unavailable from its own local cache 64. Since the processor 54 does not contain a copy of the requested data, the cache line of the processor may be initially in the I-state (invalid) for that data or it may contain different data altogether. For purposes of simplicity of explanation, the starting state of the source processor cache line for this and other examples is the I-state. The processor 54, operating as the source processor, transmits a source broadcast read snoop (XREAD) to the other processors 56, 58, and 60, to the memory 72, and to the other nodes 82 via the interconnect 62.

In this example, it is assumed that, at the time of the XREAD request, at least one other processor (e.g., processor 56) in the system 50 has an outstanding XREAD request for the same data. It is further assumed that yet another processor (e.g., processor 58) is an owner processor, i.e., a cache ordering point for the data. For this example, assume that the owner processor 58 has a copy of the data in an M-state cache line of the owner processor.

For purposes of this example, assume that the cache ordering point is in the process of migrating from the owner processor 58 to the processor 56 at the time the processor 56 receives the XREAD request from the processor 54 (e.g., in response to the processor 56 receiving migratory data). The owner processor 58 transitions to the T-state after providing the D-DATA response to the processor 56. In this scenario, the processor 56 provides a CONFLICT message in response to the XREAD request of the processor 54 since the data state machine at the target processor is in the D-DATA state (see, e.g., Table 5). Also, the owner processor 58 provides a CONFLICT response to the processor 54 since the XREAD request from the processor 54 finds the owner processor 58 in the T-state. The memory 72 provides an M-DATA response to the XREAD request of the processor 54. Processor 60 provides a MISS response to the XREAD request of processor 54 because processor 60 is invalid for the cache line. As a result, after all responses to the XREAD request of the processor 54 have been received from the processors of the system 50, the data state machine associated with the XREAD request of the processor 54 is in the M-DATA state. Referring to the conflict state diagram of FIG. 3, the CONFLICT response from the processor 56 and/or the owner processor 58 transitioned the conflict state machine associated with the XREAD request of the processor 54 in the CONFLICT state. After all responses to the XREAD request of the processor 54 have returned from the processors in the system 50, the resulting action taken at the processor 54 is determined in accordance with Table 7.

Referring to Table 7, since the data state machine is in the M-DATA state and the conflict state machine is in the CONFLICT state, the resulting action taken at the processor 54 is to transition to the FPP mode and reissue an FPP request for the data. Thus, in this example, according to the cache coherency protocol described herein, the CONFLICT cannot be overcome and the system 50 reverts to the FPP mode to resolve the transaction with the processor 54. In doing so, the cache coherency protocol avoids filling incorrect or stale data at the processor 54.

The above example illustrates a conflict scenario that leads to one of the data state/conflict state combinations of Table 7. It will be appreciated that the other data state/conflict state combinations of Table 7 would similarly result in the corresponding source processor actions illustrated in Table 7. It will also be appreciated that the various data state and conflict state combinations of Table 7 may arise in a great number of circumstances involving conflict and non-conflict scenarios. The action taken at the source processor will be determined according to the data state/conflict state combination after all responses have been received at the source processor.

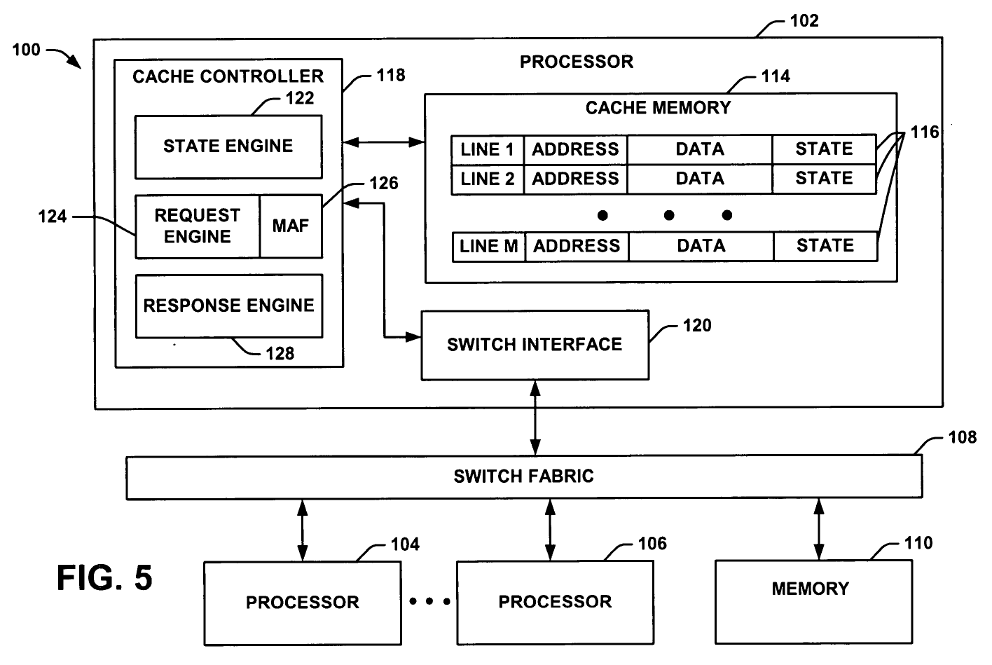

FIG. 5 depicts an example of another multi-processor system 100 that includes a plurality of processors 102, 104 and 106 in communication with each other via a switch fabric 108. The system 100 also includes associated memory 110, which can be organized as a single address space that is shared by the processors 102, 104, and 106. For example, the memory 110 can be implemented as a plurality of separate memory modules associated with each of the respective processors 102, 104, and 106 for storing data. The system 100, for example, can be implemented as an integrated circuit or as circuitry containing plural integrated circuits.

The system 100 can employ a source broadcast or source-snoopy cache coherency protocol. For this type of protocol, a source processor 102, 104, and 106 can issue a source broadcast request to all other processors in the system and to the memory 110. In the event that conflict arises, or the source broadcast request otherwise fails, the system 100 can transfer to a forward-progress protocol, such as a null-directory or other directory-based protocol.

In a null-directory-based protocol, for example, the memory 110 includes home nodes for each cache line. Instead of issuing a broadcast to all cache targets, the source issues a single request to the home node for such data. The home node thus operates as static ordering point for requested data since all requests are sent to the home node for ordering before snoops are broadcast. This tends to add an additional hop for the majority of references compared with a broadcast-based protocol described above. If the system employs a standard directory-based protocol, ordering is implemented, but the memory 110 employs associated directories that facilitate locating the data (e.g., based on the directory state associated with the requested data). In a standard directory protocol, there will be times when the directory can indicate that there are no cached copies, and thus the home node can respond with the data without issuing any snoops to the system 100.

The processor 102 includes cache memory 114 that contains a plurality of cache lines 116 (e.g., lines 1-M, where M is a positive integer, M≧1). Each cache line 116 can contain one or more memory blocks. A tag address (ADDRESS) is associated with the data contained in each cache line 116. Additionally, each cache line 116 can contain state information identifying the state of the data contained at that cache line. Examples of states that can be associated with each cache line 116 are identified above in Table 1.

A cache controller 118 is associated with the cache memory 114. The cache controller 118 controls and manages access to the cache memory, including requests for data and responses. The cache controller 118 communicates requests and responses via a switch interface 120 that is coupled with the switch fabric 108. The switch interface 120, for example, includes an arrangement of queues (e.g., input and output queues) or other data structures that organize both requests and responses issued by the processor 102 as well as requests and responses for execution by the processor.

In the example of FIG. 5, the cache controller 118 includes a state engine 122 that controls the state of each respective line 116 in the cache memory 114. The state engine 122 is programmed and/or configured to implement state transitions for the cache lines 116 based on predefined rules established by the cache coherency protocol described herein. For example, the state engine 122 can modify the state of a given cache line 116 based on requests issued by the processor 102. Additionally, the state engine 122 can modify the state of a given cache line 116 based on responses received at the processor 102 for the given tag address, such as may be provided by another processor 104, 106 and/or the memory 110.

The cache controller 118 also includes a request engine 124 that sends requests to the system 100. The request engine 124 employs a miss address file (MAF) 126 that contains MAF entries for outstanding requests associated with some subset of the locations in the cache memory 114. The MAF can be implemented as a table, an array, a linked list or other data structure programmed to manage and track requests for each cache line. For example, when the processor 102 requires data associated with a given address for a given line 116, the request engine 124 creates a corresponding entry in the MAF 126. The MAF entry includes fields that identify, for example, the address of the data being requested, the type of request, and response information received from other nodes in response to the request. The request engine 124 thus employs the MAF 126 to manage requests issued by the processor 102 as well as responses to such requests. The request engine can employ a data state machine and conflict state machine (see, e.g., FIGS. 2 and 3) associated with each MAF entry for helping to manage a data state and a conflict state associated with each MAF entry.

The cache controller 118 also includes a response engine 128 that controls responses provided by the processor 102. The processor 102 provides responses to requests or snoops received via the switch interface 120 from another processor 104 and 106 or memory 110. The response engine 128, upon receiving a request from the system 100, cooperates with the state engine 122 and the MAF 126 to provide a corresponding response based on the type of request and the state of data contained in the cache memory 114. For example, if a MAF entry exists for a tag address identified in a request received from another processor or memory, the cache controller can implement appropriate conflict resolution defined by the coherency protocol. The response engine thus enables the cache controller to send an appropriate response to requesters in the system 100. A response to a request can also cause the state engine 122 to effect a state transition for an associated cache line 116.

By way of example, assume that the processor 102 requires data not contained locally in its cache memory 114. The request engine 124 will create a MAF entry in the MAF 126, corresponding to the type of request and the tag address associated with data required. For a read request, for example, the processor 102 issues an XREAD request and allocates a corresponding entry in the MAF 126. For this example, assume that the processor 104 is an owner node including the data in a D-state cache line and assume that the processor 106 has an outstanding XRDINVAL MAF for the same data that has not yet been received at the owner processor 104. The cache controller 118 broadcasts a source snoop XREAD request to the nodes of the system 100 via the switch interface 120 and switch fabric 108.

In response to receiving the XREAD request from the source node 102, the memory 110 provides an M-DATA response. The owner node 104 provides a D-DATA response and transitions to the T-state (see, e.g., Table 4). The processor 106, having an outstanding XRDINVAL MAF for the data, responds to the XREAD by providing a non-data CONFLICT response (see, e.g., Table 5). After all responses have been received from the nodes of the system 100, the data state machine of the MAF 126 is in the D-DATA state and the conflict state machine of the MAF 126 is in the CONFLICT state. The resulting action taken at the source processor 102 is determined in accordance with Table 7.

Referring to Table 7, since the data state machine of MAF 126 is in the D-DATA state and the conflict state machine of MAP 126 is in the CONFLICT state, the resulting action taken at source processor 102 is to fill a cache line 116 of cache 114 with the D-DATA and employ the state engine 122 to transition the source processor cache line 116 associated with the data to the D-state. The source processor 102 then transitions to the migratory mode and employs the request engine 124 to broadcast an XINVAL command to all other processors. While the XINVAL is pending, the source processor 102 employs the response engine 128 to respond to any third party snoops with a CONFLICT message (see, e.g., Table 5). When all XINVAL acknowledgement responses have been received, the source processor 102 initiates an MACK/MACK-ACK sequence with the target processor 104 to complete the ordering point migration. Thus, in this conflicting read/write scenario involving migratory data, according to the cache coherency protocol described herein, the data migrates from the owner processor 104 to the source processor 102 and takes steps to correct any incorrect or stale data that may have been filled at other processors in the system 100.

The various examples of conflict scenarios depicted herein so far have been addressed from the perspective of only one of the conflicting processors in a given conflict scenario and considering the conditions at the other node to be essentially mostly static. These examples have not addressed the fact that in a conflict scenario, the source node and target node designations are relative. To illustrate this point, consider two processors, A and B, each of which have outstanding requests for the same data and therefore conflict with each other. From the point of view of processor A, processor A is the source node and processor B is the target node. From the point of view of processor B, processor B is the source node and processor A is the target node. It will thus be appreciated that in conflict scenarios, conflicting requests are handled by the cache coherency protocol at both conflicting nodes in the manner described herein. It will also be appreciated that the manner in which the requests of the conflicting processors are handled can depend in large part on the timing of the creation and/or retirement of the respective MAF entries at the conflicting processors and the timing of the respective snoops/responses of the conflicting processors.

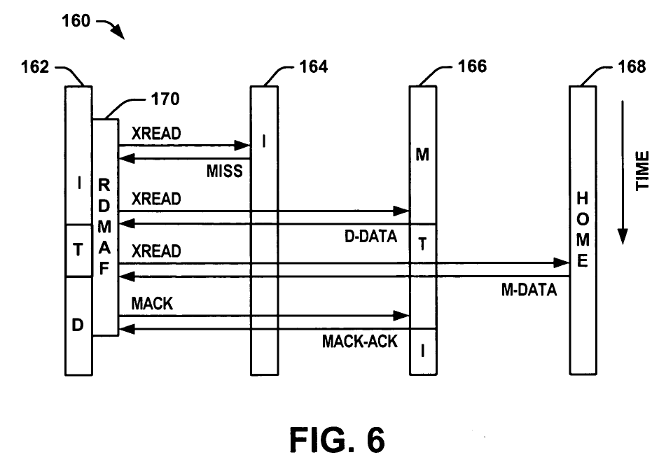

In view of the foregoing structural and functional features described above, certain methods that can be implemented using a coherency protocol will be better appreciated with reference to FIGS. 6-12. FIGS. 6-10 depict various example timing diagrams for conflict scenarios that can arise in a multi-processor system employing a cache coherency protocol as described herein. Each of the examples illustrates various interrelationships between requests and responses and state transitions that can occur for a given memory tag address in different memory devices or caches. In each of these examples, time flows in the direction of an arrow labeled “TIME.” Those skilled in the art may appreciate various other conflict scenarios that can arise in a multi-processor system employing a cache coherency protocol as described herein.

FIG. 6 illustrates a network 160 that includes processor nodes 162, 164, and 166 and a home node 168. Initially, nodes 162 and 164 are in an I-state for a particular cache line and node 166 is an owner node in the M-state for the cache line. The node 168 contains a memory copy of the data associated with the cache line. In this example case, node 162 allocates a RDMAF entry 170 for the requested data and broadcasts an XREAD request to node 164, which, being in the I-state, returns a MISS response. Next, node 162 receives a D-DATA response to an XREAD request broadcast from node 162 to node 166. Node 166 transitions to the T-state upon providing the D-DATA response to node 162. Node 162 transitions to the T-state upon receiving the D-DATA response from node 166. Next, node 162 receives an M-DATA response to an XREAD request broadcast from node 162 to home node 168. Node 162 transitions to the D-state upon receiving the M-DATA response from node 168 because, at this point, responses have been received from all of the nodes to which node 162 broadcast the XREAD snoop request.

Referring to FIG. 2, for example, the data state machine for the RDMAF 170 at node 162, having received the M-DATA response from the home node 168 and D-DATA from the node 166, transitions to the D-DATA state. Referring to FIG. 3, the conflict state machine for the RDMAF 170 at node 162, having received no conflict responses, remains in the NO_CONFLICT state. The D-DATA data state machine for RDMAF 170 indicates that migration of the data to node 162 is occuring and the NO_CONFLICT conflict state machine indicates that there are no misleading RD-CONF states at other nodes (e.g., node 164) and thus steps to clean-up incorrect or stale data (e.g., XINVAL commands) are not necessary. Referring to the XREAD snoop resolution Table 7, for the data state/conflict state combination of D-DATA and NO_CONFLICT, the action taken at node 162 for the RDMAF 170 is to fill the cache line at node 162 and initiate a MACK/MACK-ACK sequence to complete the data migration from node 166 to node 162. Node 166 acknowledges the MACK from node 162 by providing an MACK-ACK response and transitioning to the I-state. When the MACK-ACK response is received from node 166, the migration is complete, the RDMAF 170 is retired, and the node 162 is left in the D-state.

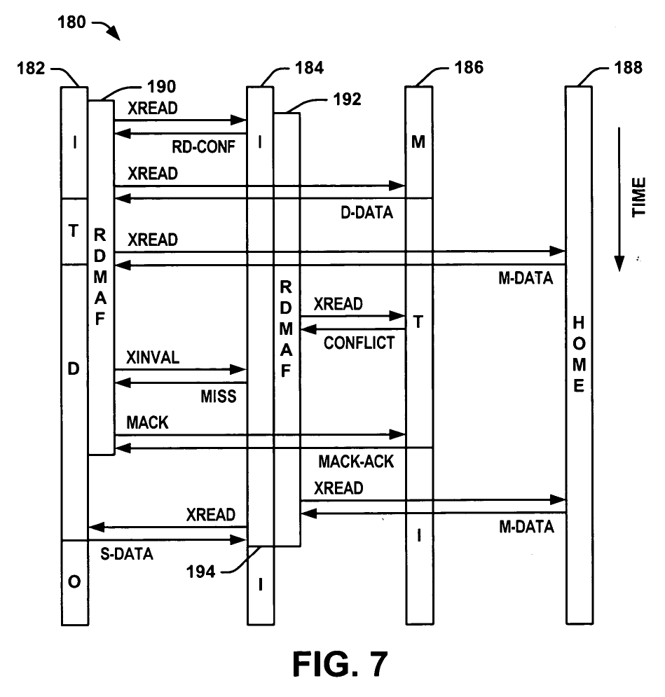

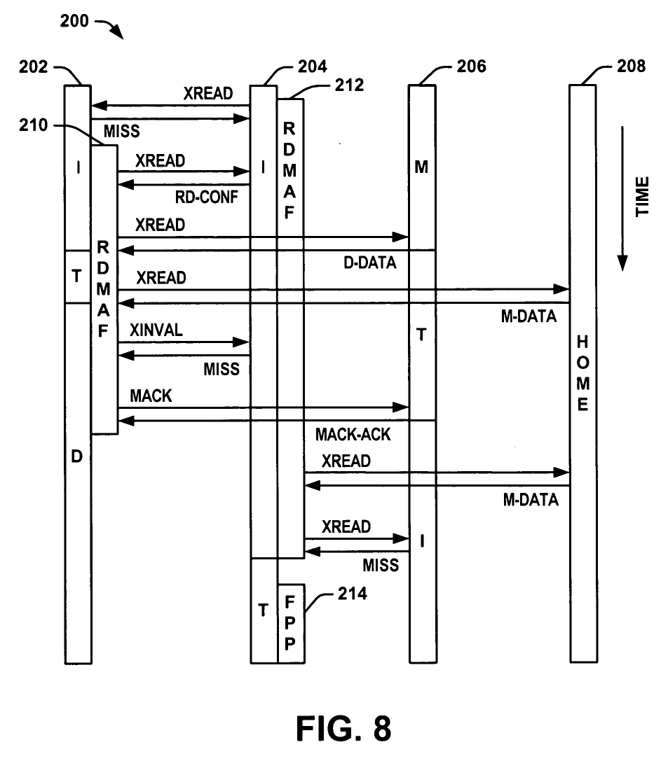

FIG. 7 illustrates a network 180 that includes processor nodes 182, 184, and 186 and a home node 188. Initially, nodes 182 and 184 are in an I-state for a particular cache line and node 186 is an owner node in the M-state for the cache line. The home node 188 contains a memory copy of the data associated with the cache line. In this example case, node 182 allocates a RDMAF 190 and, shortly thereafter, node 184 allocates a RDMAF 192. Next, node 182 receives a RD-CONF response to an XREAD request broadcast from node 182 to node 184. Next, node 182 receives a D-DATA response to an XREAD request broadcast from node 182 to node 186. Node 186 transitions to the T-state after providing the D-DATA response to node 182. Node 182 transitions to the T-state when the D-DATA response is received from node 186. Next, node 182 receives an M-DATA response to an XREAD request broadcast from node 182 to home node 188. Node 182 transitions to the D-state when the M-DATA response is received from node 188 because, at this point, responses have been received from all of the nodes to which node 182 broadcast the XREAD snoop request.

The data state machine (see, e.g., FIG. 2) for the RDMAF 190 of node 182, having received the M-DATA response from the home node 188 and D-DATA from the owner node 186, transitions to the D-DATA state. Referring to FIG. 3, the conflict state machine for the RDMAF 190 at node 182, having received the RD-CONF response, is in the RD-CONF state. Referring to Table 7, for the data state/conflict state combination of D-DATA and RD-CONF, the action taken at node 182 for the RDMAF 190 is to fill the cache line with the D-DATA and transition node 182 to the migratory mode. In the migratory mode, node 182 broadcasts an XINVAL command to node 184, which returns an acknowledging MISS response. When the MISS response from node 184 for the XINVAL is received, node 162 initiates an MACK/MACK-ACK sequence with the owner node 186 to complete the ordering point migration. The owner node 186 acknowledges the MACK from node 182 by providing an MACK-ACK response and transitioning from the T-state to the I-state. When the MACK-ACK response is received at node 182 from node 186, the migration is complete, the RDMAF 190 is retired, and node 182 is left in the D-state.

As shown in FIG. 7, node 184 receives a CONFLICT response to an XREAD request broadcast from node 184 to node 186 while node 186 is in the T-state (see, e.g., Table 4). Thereafter, node 184 receives the XINVAL command from node 182, which would have transitioned the RDMAF 192 of node 184 to the CONFLICT state had the CONFLICT message not been received from node 186. Thereafter, node 184 receives an M-DATA response to an XREAD request broadcast from node 184 to home node 188. After the RDMAF 190 of node 182 has been retired, node 184 receives an S-DATA response to an XREAD request broadcast from node 184 to node 182. Node 182 transitions to the O-state upon providing the S-DATA response to node 184. At this point, responses have been received from all of the nodes to which node 184 broadcast the XREAD snoop request.

Referring to FIG. 2, the data state machine for the RDMAF 192 at node 184, having received the M-DATA response from the home node 188 and the S-DATA response from node 182, transitions to the S-DATA state. Referring to FIG. 3, the conflict state machine for the RDMAF 192 at node 184, having received the CONFLICT response from node 186, transitions to the CONFLICT state. Referring to Table 7, for the data state/conflict state combination of S-DATA and CONFLICT, the action taken at node 184 for the RDMAF 192 is to FILL-INVALID, i.e., fill node 184 with the data and transition node 184 to the I-state, as indicated at 194. Node 184 is thus afforded a single use of the data. If node 184 requires the data for further use, node 184 can issue another SSP source broadcast read request for the data.

In this conflicting read scenario involving migratory data, according to the cache coherency protocol described herein, the cache ordering point migrates from node 186 to node 182 in response to the XREAD request. Any incorrect or stale data that may have been filled at other nodes in the system 180 is cleaned-up via the XINVAL command issued by node 182 in the migratory mode. The RD-CONF conflict state machine indicates to node 182 that this clean-up of misleading RD-CONF states at other nodes may be necessary.

FIG. 8 illustrates a network 200 that includes processor nodes 202, 204, and 206 and a home node 208. Initially, nodes 202 and 204 are in an I-state for a particular cache line and node 206 is an owner node in the M-state for the cache line. The node 208 contains a memory copy of the data associated with the cache line. In this example case, node 204 allocates a read MAF entry (RDMAF) 212 and, thereafter, node 204 broadcasts an XREAD to node 202, which returns a non-data MISS response. Next, node 202 allocates a RDMAF entry 210 for the requested data and broadcasts an XREAD request to node 204, which returns a RD-CONF response since the data state machine of RDMAF 212 is not in the D-DATA state, i.e., migration has not yet begun at node 204 (see, e.g., Table 5). The XREAD request from node 202 also sets the conflict state machine for the RDMAF to the RD-CONF state. Next, node 202 receives a D-DATA response to an XREAD request broadcast from node 202 to node 206. Node 206 transitions to the T-state upon providing the D-DATA response to node 202. Node 202 transitions to the T-state upon receiving the D-DATA response from node 206. Next, node 202 receives an M-DATA response to an XREAD request broadcast from node 202 to home node 208. Node 202 transitions to the D-state upon receiving the M-DATA response from node 208 because at this point, responses have been received from all of the nodes to which node 202 broadcast the XREAD snoop request.

Referring to FIG. 2, for example, the data state machine for the RDMAF 210 at node 202, having received the M-DATA response from the home node 208 and D-DATA from the node 206, transitions to the D-DATA state. Referring to FIG. 3, the conflict state machine for the RDMAF 210 at node 202, having received the RD-CONF response from node 204, transitions to the RD-CONF state. The D-DATA data state machine indicates that migration to node 202 is in process and the RD-CONF conflict state machine indicates that clean-up may be required at other nodes (e.g., node 204) to correct stale or incorrect data filled at the other nodes. Referring to the XREAD snoop resolution Table 7, for the data state/conflict state combination of D-DATA and RD-CONF, the action taken at node 202 for the RDMAF 210 is to fill the cache line at node 202 and transition node 202 to the migratory mode. In the migratory mode, node 202 broadcasts an XINVAL request to node 204, which returns a MISS response. The XINVAL places the RDMAF at node 204 in the CONFLICT state (see, e.g., Table 5). When the MISS response from node 204 is received at node 202, node 202 initiates an MACK/MACK-ACK sequence to complete the data migration from node 206 to node 202. Node 206 acknowledges the MACK from node 202 by providing an MACK-ACK response and transitioning to the I-state. When the MACK-ACK response is received from node 206, the migration is complete, the RDMAF 210 is retired, and the node 202 is in the D-state.

After node 202 has transitioned to the D-state, node 204 receives an M-DATA response to an XREAD request broadcast from node 204 to home node 208. Node 204 then receives a MISS response to an XREAD request broadcast from node 204 to node 206 because the XREAD request finds node 206 in the I-state. At this point, responses have been received from all of the nodes to which node 204 broadcast snoop requests. Referring to FIG. 2, the data state machine for the RDMAF 212 at node 204, having received the M-DATA response from the home node 208 and MISS responses from nodes 202 and 206, transitions to the M-DATA state. Referring to FIG. 3, the conflict state machine for the RDMAF 212 at node 204, having received the XINVAL request from node 202, transitions to the CONFLICT state. Referring to Table 7, for the data state/conflict state combination of M-DATA and CONFLICT, the action taken at node 204 for the RDMAF 212 is to retire the RDMAF 212, transition node 204 to the T-state, transition to the FPP mode and reissue the request using an FPP request, as indicated at 214. Thus, in the read conflict scenario involving migratory data of the example of FIG. 8, the cache coherency protocol described herein forces node 204 to transition to the FPP mode due to the CONFLICT state created by the XINVAL issued by node 202. It should be noted that, in the scenario illustrated in FIG. 8, node 204 is guaranteed to either see the T-state at node 206 and thus transition to the CONFLICT state or receive the XINVAL command from node 202 and thus transition to the CONFLICT state. This can be advantageous since, as shown in FIG. 8, the only data response received at node 204 is M-DATA, which could likely be stale or incorrect since the data had been in the modified state (M-state) at node 206 without write-back.

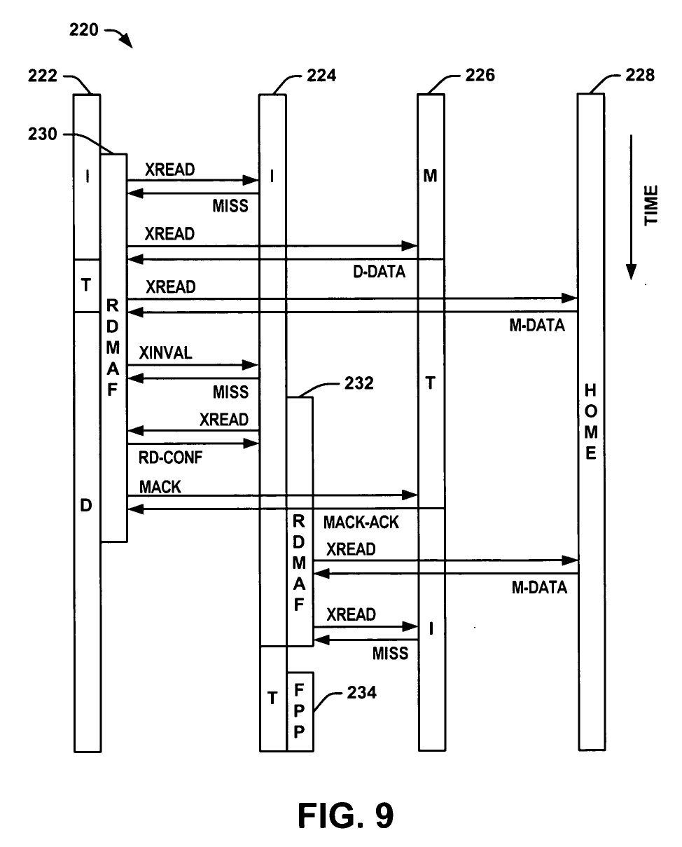

FIG. 9 illustrates a network 220 that includes processor nodes 222, 224, and 226 and a home node 228. Initially, nodes 222 and 224 are in an I-state for a particular cache line and node 226 is an owner node in the M-state for the cache line. The home node 228 contains a memory copy of the data associated with the cache line. In this example case, node 222 allocates a RDMAF 230. For this example, assume that node 222 receives a CONFLICT message from another node (not shown), as indicated at 236. Node 222 receives a MISS response to an XREAD request broadcast from node 222 to node 224. Next, node 222 receives a D-DATA response to an XREAD request broadcast from node 222 to node 226. Node 226 transitions to the T-state upon providing the D-DATA response to node 222. Node 222 transitions to the T-state upon receiving the D-DATA response from node 226. Next, node 222 receives an M-DATA response to an XREAD request broadcast to home node 228. Node 222 transitions to the D-state upon receiving the M-DATA response from node 228 because, at this point, responses have been received from all of the nodes to which node 222 broadcast the XREAD snoop request.

The data state machine (see, e.g., FIG. 2) for RDMAF 230 of node 222, having received the M-DATA response from the home node 228 and D-DATA from the owner node 226, transitions to the D-DATA state. Referring to FIG. 3, the conflict state machine for the RDMAF 230 at node 222, having received the CONFLICT message 236, transitions to the CONFLICT state. Referring to the XREAD snoop resolution Table 7, for the data state/conflict state combination of D-DATA and CONFLICT, the action taken at node 222 for the RDMAF 230 is to fill the cache line with the D-DATA and transition to the migratory mode. In the migratory mode, node 222 issues an XINVAL to node 232 to clean-up incorrect or stale data that may have been filled in the cache line at node 232. Next, node 222 initiates an MACK/MACK-ACK sequence with the owner node 226 to complete the ordering point migration. The owner node 226 acknowledges the MACK from node 222 by providing an MACK-ACK response and transitioning from the T-state to the I-state. When the MACK-ACK response is received from node 226, the migration is complete, the RDMAF 230 is retired, and node 222 is left in the D-state. The cache ordering point for the data thus migrates from node 226 to node 222.

After node 222 issues the XINVAL command and receives the MISS response from node 224, node 224 allocates a RDMAF 232 and receives a CONFLICT response to an XREAD request broadcast from node 224 to node 222 because the RDMAF 232 is an XREAD and the data state machine is in the D-DATA state (see, e.g., Table 5). Next, node 224 receives an M-DATA response to an XREAD request broadcast from node 224 to home node 228. Next, node 224 receives a MISS response to an XREAD request broadcast from node 224 to node 226 because node 224 is in the I-state (see, e.g., Table 4).

At this point, responses have been received from all of the nodes to which node 224 broadcast the XREAD snoop request. Referring to FIG. 2, the data state machine for the RDMAF 232 at node 224, having received the M-DATA response from the home node 168, transitions to the M-DATA state. Referring to FIG. 3, the conflict state machine for the RDMAF 232 at node 224, having received the CONFLICT response from node 222, transitions to the CONFLICT state. Referring to Table 7, for the data state/conflict state combination of M-DATA and CONFLICT, the action taken at node 224 for the RDMAF 232 is to transition to the FPP mode and issue an FPP request for the data. Thus, in this read conflict scenario involving migratory data of the example of FIG. 9, node 224 is forced to the FPP mode, which can be advantageous since, as shown in FIG. 9, the only data response received at node 224 is M-DATA, which could likely be stale or incorrect since the data had been in the modified state (M-state) at node 226 without write-back.

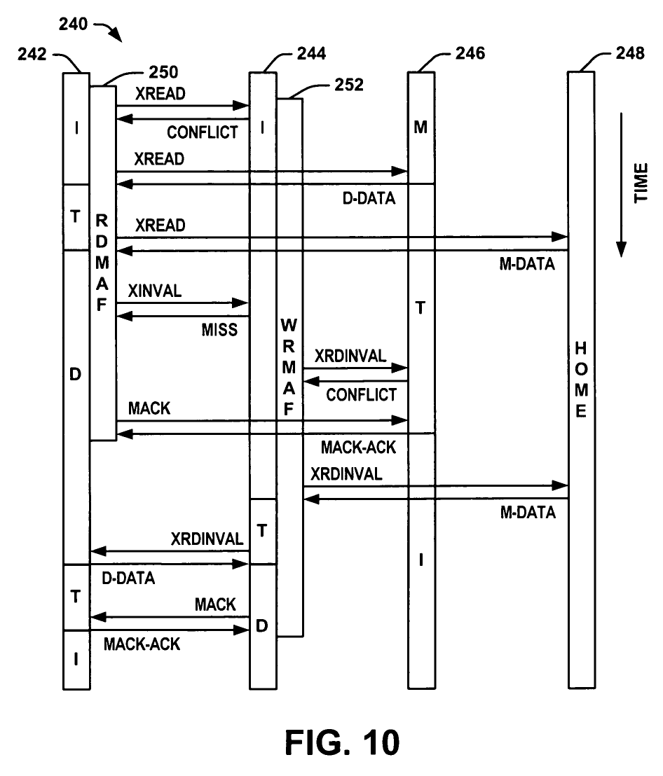

FIG. 10 illustrates a network 240 that includes processor nodes 242, 244, and 246 and a home node 248. Initially, nodes 242 and 244 are in an I-state for a particular cache line and node 246 is an owner node in the M-state for the cache line. The home node 248 contains a memory copy of the data associated with the cache line. In this example case, node 242 allocates a RDMAF 250 and, shortly thereafter, node 244 allocates a write MAF (WRMAF) 252. Next, node 242 receives a CONFLICT response to an XREAD request broadcast from node 242 to node 244 due to the XREAD request finding the WRMAF 252 at node 244 (see, e.g., Table 5). Next, node 242 receives a D-DATA response to an XREAD request broadcast from node 242 to node 246. Node 246 transitions to the T-state after providing the D-DATA response to node 242. Node 242 transitions to the T-state when the D-DATA response is received from node 246. Next, node 242 receives an M-DATA response to an XREAD request broadcast from node 242 to home node 248. Node 242 transitions to the D-state after receiving the M-DATA response from home node 248 because, at this point, responses have been received from all of the nodes to which node 242 broadcast the XREAD snoop request.

The data state machine (see, e.g., FIG. 2) for the RDMAF 250 of node 242, having received the M-DATA response from the home node 248 and D-DATA from the owner node 246, transitions to the D-DATA state. Referring to FIG. 3, the conflict state machine for the RDMAF 250 at node 242, having received the CONFLICT response from node 244, is in the CONFLICT state. The D-DATA data state machine indicates that migration to node 242 is in process and the CONFLICT state machine indicates that clean-up may be required at other nodes (e.g., node 244) is required so that stale or incorrect data is not filled at the other nodes. Referring to Table 7, for the data state/conflict state combination of D-DATA and CONFLICT, the action taken at node 242 for the RDMAF 250 is to fill the cache line with the D-DATA and transition node 242 to the migratory mode. In the migratory mode, node 242 broadcasts an XINVAL request to node 244, which returns a MISS response. When the MISS response from node 244 for the XINVAL is received, node 242 initiates an MACK/MACK-ACK sequence with the owner node 246 to complete the ordering point migration. The owner node 246 acknowledges the MACK from node 242 by providing an MACK-ACK response and transitioning from the T-state to the I-state. When the MACK-ACK response is received from node 246, the migration is complete, the RDMAF 250 is retired, and node 242 is left in the D-state.

As shown in FIG. 10, node 244 receives a CONFLICT response to an XRDINVAL request broadcast from node 244 to node 246 while node 246 is in the T-state (see, e.g., Table 4). Thereafter, node 244 receives an M-DATA response to an XRDINVAL request broadcast from node 244 to home node 248. After RDMAF 250 of node 242 has been retired, node 244 receives a D-DATA response to an XRDINVAL request broadcast from node 244 to node 242. Node 242 transitions to the T-state upon providing the D-DATA response to node 244. Node 244 transitions to the T-state upon receiving the D-DATA response from node 242 because, at this point, responses have been received from all of the nodes to which node 244 broadcast the XRDINVAL snoop request.

Referring to FIG. 2, the data state machine for the WRMAF 252 at node 244, having received the M-DATA response from the home node 168 and the D-DATA response from node 242, transitions to the D-DATA state. Referring to FIG. 3, the conflict state machine for the WRMAF 252 at node 244, having received the XINVAL command from node 242 and/or the CONFLICT response from node 246, transitions to the CONFLICT state. Referring to Table 9, for the data state/conflict state combination of D-DATA and CONFLICT, the action taken at node 244 for the WRMAF 252 is to fill node 244 with the D-DATA and initiate a MACK/MACK-ACK sequence with node 242 to complete the ordering point migration from node 242 to node 244. Node 242 acknowledges the MACK from node 224 by providing an MACK-ACK response and transitioning from the T-state to the I-state. When the MACK-ACK response is received from node 222, the migration is complete, the RDMAF 232 is retired, and node 224 is left in the D-state. The cache ordering point for the data thus migrates from node 222 to node 224.

Thus, in the read/write conflict scenario involving migratory data in the example of FIG. 10, according to the cache coherency protocol described herein, the cache ordering point first migrates from node 246 to node 242 in response to the XREAD request of node 242, and then migrates from node 242 to node 244 in response to the XRDINVAL request of node 244. During migration of the data from node 246 to node 242, node 242, being in the migratory mode, issues the XINVAL command to clean-up any stale or incorrect data filled at the other nodes. During migration of the data from node 242 to node 244, the XRDINVAL request cleans-up any stale or incorrect data filled at the other nodes due to its inherent invalidate function.

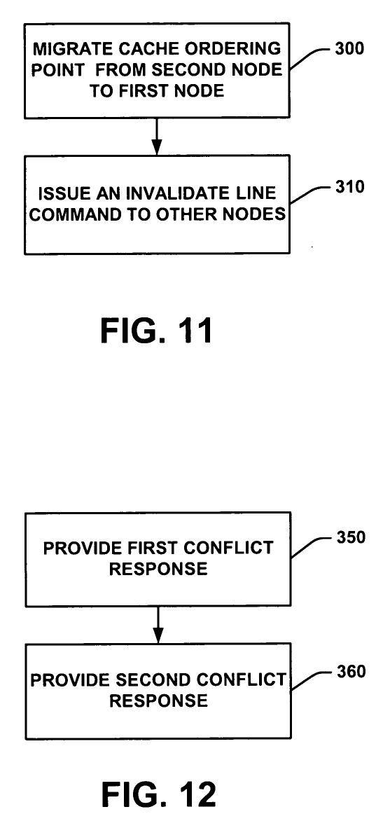

FIG. 11 depicts a method that includes migrating a cache ordering point for a line of data from a second node of a system to a first node of a system, as indicated at 300. The method also includes issuing an invalidate line command for the line of data to other nodes of the system in response to migrating the cache ordering point from the second node to the first node, as indicated at 310.

FIG. 12 depicts another method that includes providing from a first node a first conflict response to source broadcast requests for data from other nodes while a source broadcast request for the data is pending at the first node, as indicated at 350. The method also includes providing from the first node a second conflict response to the other source broadcast requests for the data from the other nodes in response to receiving a conflict response and an ownership data response at the first node, as indicated at 360.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. A system comprising:
a first node that provides a source broadcast request for data, the first node being operable to respond in a first manner to other source broadcast requests for the data while the source broadcast request for the data is pending at the first node;
the first node being operable to respond in a second manner to the other source broadcast requests for the data in response to receiving an ownership data response at the first node.

2. The system of claim 1, wherein the ownership data response comprises an indication to the first node that the data associated with the ownership data response comprises migratory data.

3. The system of claim 2, wherein the migratory data comprises a cache ordering point for serializing source broadcast requests for the data, the cache ordering point migrating to the first node from a node that provides the ownership data response.

4. The system of claim 3, wherein the first node is operative to provide an ownership data response to a second node requesting the data, such that the cache ordering point migrates from the first node to the second node.

5. The system of claim 1, wherein the source broadcast request from the first node comprises a source broadcast read request, the first node, when responding in the first manner, provides a first response to the other source broadcast requests for the data indicating that the first node has a conflicting read request for the data.

6. The system of claim 5, further comprising a second node that provides one of the other source broadcast requests for the data and receives the first response from the first node, the second node being operative to fill a shared copy of data received from a third node in response to the one of the other source broadcast requests for the data.

7. The system of claim 5, further comprising a second node that provides one of the other source broadcast requests for the data and receives the first response from the first node, the second node being operative to fill a copy of data received from a home node for the data.

8. The system of claim 1, wherein the first node, when responding in the second manner, provides a second response to the other source broadcast requests for the data indicating that the source broadcast request from the first node is a conflicting request for the data and that migration of the data to the first node is in progress.

9. The system of claim 8, further comprising a second node that provides one of the other source broadcast requests for the data and receives the second response from the first node, the second node being operative to employ a copy of the data received from a third node for only a single use.

10. The system of claim 8, further comprising a second node that provides one of the other source broadcast requests for the data and receives the second response from the first node, the second node being operative to employ a forward progress technique to obtain the data.

11. The system of claim 10, wherein the forward progress technique comprises a forward progress cache coherency protocol.

12. The system of claim 1, wherein the first node employs an invalidate line command to other nodes of the system to remove incorrect copies of the data and any stale copies of the data cached at the other nodes of the system.

13. The system of claim 1, wherein the source broadcast request provided by the first node is broadcast using a source broadcast cache coherency protocol.

14. The system of claim 1, wherein the first node defines a processor having an associated cache, the associated cache of the processor comprising a plurality of cache lines, each cache line having a respective tag address that identifies associated data and each cache line having state information that indicates a state of the associated data for the respective cache line, the processor being capable of communicating with other nodes of the system through an interconnect, the system further comprising a cache controller associated with the processor, the cache controller being operative to manage data requests and responses for the associated cache of the processor, the cache controller effecting state transitions associated with the data in the associated cache of the processor based on the data requests and responses for the associated cache of the processor.

15. The system of claim 1, wherein the system implements a hybrid cache coherency protocol wherein the first node employs a source broadcast-based protocol to issue the source broadcast request for the data, the first node employing an associated forward progress protocol to reissue a request for the data in response to the request failing in the source broadcast protocol.

16. A multi-processor network comprising:
a source processor node that provides a source broadcast read request for data;
the source processor node issuing an invalidate line command to other processor nodes of the system in response to receiving a data response that transfers a cache ordering point for the data to the source processor node.

17. The multi-processor network of claim 16, wherein the invalidate line command issued by the source processor node removes incorrect cached copies of the data at the other processor nodes of the system and stale copies of the data filled at the other processor nodes of the system.

18. The multi-processor network of claim 16, wherein the source processor node is operative to provide a first conflict response to source broadcast requests for the data from the other processor nodes prior to receiving the data response that transfers the cache ordering point for the data to the source processor node,
the source processor node being operative to provide a second conflict response to at least one source broadcast request for the data from at least one of the other processor nodes in response to the source processor node receiving a conflict response and receiving the data response that transfers the cache ordering point for the data to the source processor node.

19. The system of claim 18, wherein the source processor node provides the first response to the source broadcast requests for the data from the other processor nodes when the source processor node has a pending conflicting read request for the data.

20. The system of claim 19, wherein the other processor nodes receiving the first response from the source processor node are operative to fill a copy of the data received from at least one of the other processor nodes and from system memory.

21. The system of claim 18, wherein the source processor node provides the second response to the source processor node receiving a request for the data that conflicts with the source broadcast request for the data after migration of the data to the source processor node has begun.

22. The system of claim 21, wherein one of the other processor nodes comprises a second processor node that provides a respective one of the other source broadcast requests for the data and receives the second response from the first node, the second processor node being operative to employ a copy of the data received from a third node for a single use.

23. The system of claim 21, wherein one of the other processor nodes comprises a second processor node that provides one of the other source broadcast requests for the data according to broadcast-based protocol, the second processor node being operative to employ a forward progress technique to obtain the data in response to the second response from the first node.

24. The system of claim 23, wherein the forward progress technique comprises a forward progress cache coherency protocol.

25. A system comprising:
means for broadcasting a source broadcast request for data from a first node; and
means for issuing from the first node an invalidate line command to other nodes of the system in response to receiving a conflict response from at least one other node in the system and a data response transferring a cache ordering point for the data to the first node.

26. The system of claim 25, further comprising:
means for providing a first conflict response to source broadcast requests for the data from other nodes prior to receiving a data response transferring a cache ordering point for the data to the first node; and
means for providing a second conflict response to source broadcast requests for the data from other nodes in response to receiving a data response transferring a cache ordering point for the data to the first node.

27. The system of claim 26, further comprising means for filling a shared copy of the data at one of the other nodes in response receiving the first conflict response from the first node.

28. The system of claim 26, further comprising means for filling a copy of the data received from system memory at one of the other nodes in response to receiving the first conflict response from the first node.

29. The system of claim 26, further comprising means for employing a shared copy of the data for a single use at one of the other nodes in response to the one of the other nodes receiving the second conflict response from the first node.

30. The system of claim 26, further comprising means for employing a forward progress technique at one of the other nodes to obtain the data in response to receiving the second conflict response from the first node.

31. A system comprising:
means for broadcasting a source broadcast request for data from a first node;
means for providing a first conflict response to other source broadcast requests for the data from other nodes while the source broadcast for the data is pending at the first node; and
means for providing a second conflict response to the other source broadcast requests for the data from the other nodes after receiving an ownership data response at the first node while the source broadcast for the data is pending at the first node.

32. The system of claim 31, further comprising means for cleaning-up incorrect copies of the data and stale copies of the data filled at other nodes of the system in response to receiving the ownership data response at the first node.

33. The system of claim 31, further comprising means for issuing an invalidate line command to the other nodes of the system in response to receiving the ownership data response at the first node.

34. A method comprising:
migrating a cache ordering point for a line of data from a first node of a system to a second node of a system; and
issuing an invalidate line command for the line of data from the second node to other nodes of the system in response to receiving a conflict response from at least one other node in the system and to the cache ordering point migrating from the first node to the second node.

35. The method of claim 34, further comprising:
providing a first conflict response from the second node to requests for the line of data from the other nodes of the system prior to the cache ordering point migrating from the first node to the second node; and
providing a second conflict response from the second node to requests for the line of data from the other nodes after the cache ordering point migrates from the first node to the second node.

36. The method of claim 35, further comprising:
enabling a shared copy of the line of data to be filled at one of the other nodes of the system in response to receiving the first conflict response from the second node and a data response from at least another node of the system; and
enabling a copy of the line of data received from system memory to be filled at one of the other nodes of the system in response to receiving the first conflict response from the second node.

37. The method of claim 35, further comprising enabling a shared copy of the line of data to be filled at least one of the other nodes of the system for a single use by the at least one of the other nodes of the system in response to receiving the second conflict response from the first node.

38. The method of claim 35, further comprising employing a forward progress technique at the other nodes to fill the cache line in response to receiving the second conflict response from the first node.

39. A method comprising:
providing a first conflict response from a first node to source broadcast requests for data from other nodes while a source broadcast request for the data is pending at the first node; and
providing a second conflict response from the first node to the other source broadcast requests for the data from the other nodes in response to receiving a conflict response and an ownership data response at the first node.

40. A computer system comprising a plurality of nodes, the plurality of nodes employing a cache coherency protocol operative to migrate a cache ordering point for a line of data from a target node to a source node in response to a source broadcast read request for the line of data issued by the source node, the source node being operative to invalidate the line of data at other nodes of the computer system in response to receiving a conflict response and migratory data to the source broadcast read request.
